(19) United States
(12) Patent Application Publication
(10) Pub. No.: US 2020/0404855 A1
(43) Pub. Date: Dec. 31, 2020

(54) CONTINUOUS ROUND BALER

(71) Applicant: Vermeer Manufacturing Company, Pella, IA (US)

(72) Inventors: Oscar Frey, Listowel (CA); Orvie Knorr, Priceville (CA); Abraham Harder, Alma (CA)

(21) Appl. No.: 16/976,653

(22) PCT Filed: Feb. 28, 2018
(86) PCT No.: PCT/IB2018/000245

§ 371 Date: Aug. 28, 2020

(51) Int. Cl. A01F 15/10; A01F 15/07

(52) U.S. Cl. CPC A01F 15/106; A01F 15/07

(57) ABSTRACT

A baling machine includes an accumulator chamber at least partially defined by a housing. The baling machine includes an infeed assembly that is configured to deliver material to an inlet of the accumulator chamber. The baling machine includes a lower rake assembly that is positioned within the accumulator chamber and is operable to move material toward an outlet of the accumulator chamber. The baling machine includes an upper conveyor rake that is movable within the accumulator chamber. The upper conveyor rake has a first end, a second end, and a range of motion between a raised position and a lowered position. The second end of the upper conveyor rake has a greater range of motion than the first end. Through the majority of the range of motion of the upper conveyor rake, the first end is positioned closer to the lower rake assembly than the second end.

This application is being filed on 28 Feb. 2018, as a PCT International patent application.

### BACKGROUND

Baling machines that are capable of picking up a crop/forage material (e.g., straw, hay, grasses, oats, corn stalks, and the like suitable for baling) to form round bales have become an integral part of the agricultural industry. In some examples, baling machines use a baling chamber (either with a fixed volume or an expanding volume) to compress the crop material to form the round bale. Once the bale is formed in the baling chamber, the bale is ejected from the baling chamber and is later picked up for storage or use.

Traditionally, baling machines are towed behind, and powered by, a vehicle (e.g., a tractor or other like vehicle). During the baling process, an operator moves the baling machine over loose crop material that has been positioned in long piles (also known as windrows) in a field. Once the baling chamber of the baling machine is full with crop material formed into a bale, the operator stops the movement of the baling machine so that no additional crop material is picked up by the baler. Once stopped, the operator ejects the fully formed bale into the field. After the bale is ejected, the operator can resume moving the baling machine to pick up additional crop material to form additional bales.

This baling process must be repeated many times to form a plurality of bales. Stopping and starting the baling machine can be a time consuming, cumbersome, and inefficient process. Efforts have been made to produce a baling machine that is capable of continuous operation; however, improvements are desired.

### SUMMARY

The present disclosure relates generally to a baling machine. In one possible configuration, and by non-limiting example, a baling machine that has an accumulator chamber which includes a floating upper conveyor rake disposed therein is disclosed.

In one example of the present disclosure, a baling machine is disclosed. The baling machine includes an accumulator chamber at least partially defined by a housing. The accumulator chamber includes an inlet, an outlet, and an internal volume. The baling machine includes an infeed assembly that is configured to deliver material to the inlet of the accumulator chamber. The baling machine includes a lower rake assembly that is positioned within the accumulator chamber. The lower rake assembly is operable to move material toward the outlet of the accumulator chamber. The baling machine includes an upper conveyor rake that is at least partially positioned and movable within the internal volume of the accumulator chamber. The upper conveyor rake has a first end, a second end, and a range of motion between a raised position and a lowered position. The second end of the upper conveyor rake has a greater range of motion than the first end. Through the majority of the range of motion of the upper conveyor rake between the raised position and the lowered position, the first end is positioned closer to the lower rake assembly than the second end.

In another example of the present disclosure, a baling machine that has a baling chamber is disclosed. The baling machine includes an accumulator chamber at least partially defined by a housing. The accumulator chamber has an internal volume, a top side, and an opposite bottom side. The accumulator chamber includes an inlet positioned at a front of the bottom side and an outlet positioned at a rear of the bottom side. The baling machine includes an infeed assembly that includes an infeed outlet that is generally aligned and positioned below the inlet of the accumulator chamber to deposit material within the accumulator chamber through the inlet. The baling machine includes a lower rake assembly positioned at the bottom side of the accumulator chamber. The lower rake assembly is operable in a way to move material toward the outlet of the accumulator chamber. The baling machine includes an upper rake assembly that is at least partially positioned within the accumulator chamber and positioned vertically above the lower rake assembly. The upper rake assembly includes an upper conveyor rake. The upper conveyor rake includes a frame that has a first end and a second end. The upper conveyor rake is attached to the housing of the accumulator chamber at the first end of the frame. The upper conveyor rake includes a rotatable conveyor body positioned around the frame. The rotatable conveyor body is operable in at least one of a direction toward the outlet of the accumulator chamber and a direction toward the inlet of the accumulator chamber. The upper conveyor rake is movable about the first end between a raised position and a lowered position. When in the lowered position, at least a portion of the upper conveyor rake is generally vertically positioned over at least a portion of the inlet of the accumulator chamber.

In another example of the present disclosure, a method of operating a baling machine is disclosed. The method includes providing an accumulator chamber at least partially defined by a housing. The accumulator chamber has an internal volume, a top side, and an opposite bottom side. The accumulator chamber includes an inlet positioned at a front of the bottom side and an outlet positioned at a rear of the bottom side. The method includes delivering material in an upward direction to the inlet of the accumulator chamber. The method includes moving at least a portion of an upper rake assembly within the internal volume of the accumulator chamber from the bottom side of the accumulator chamber toward the top side of the accumulator chamber upon receipt of material into the accumulator chamber via the inlet. The method includes moving material from the inlet to the outlet of the accumulator chamber. The method includes delivering material from the outlet of the accumulator chamber to an inlet of a round baling chamber. The method includes forming a round bale within the baling chamber with material moved from the accumulator chamber.

In another example of the present disclosure, a baling machine is disclosed. The baling machine includes an accumulator chamber at least partially defined by a housing. The accumulator chamber has an internal volume, a top side, and an opposite bottom side. The accumulator chamber is configured to receive material at the bottom side. The accumulator chamber includes an inlet positioned at a front of the bottom side and an outlet positioned at a rear of the bottom side. The baling machine includes an upper conveyor rake that is at least partially positioned within the internal volume of accumulator chamber. The upper conveyor rake has a first end that is pivotally attached to the accumulator chamber adjacent the bottom side of the accumulator chamber. The upper conveyor rake has an opposite second end movable within the accumulator chamber. The upper conveyor rake is pivotable within the accumulator chamber between the top side and the bottom side of the accumulator chamber. The baling machine includes a baling chamber inlet that is positioned adjacent the outlet of accumulator chamber. The baling chamber inlet is operable to transfer material from the accumulator chamber to the baling chamber for creation of a round bale.

In another example of the present disclosure, a baling machine is disclosed. The baling machine includes an overshot rotor rotatable about an overshot rotor axis in a way to convey material over the top side of the overshot rotor. The baling machine includes an overshot rotor stripper positioned at a trailing edge of the overshot rotor. The baling machine includes an undershot rotor rotatable about an undershot rotor axis in a way to convey material under the undershot rotor. The undershot rotor is positioned adjacent to, and downstream from, the overshot rotor. The baling machine includes an undershot rotor drop pan that has a leading edge adjacent the trailing edge of the overshot rotor stripper. The trailing edge of the overshot rotor stripper is positioned at a distance from the undershot rotor axis that is less than a distance that the leading edge of the undershot rotor drop pan is spaced from the undershot rotor axis.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a perspective view of a baling machine, according to one example of the present disclosure.

FIG. 2 is a front view of the baling machine of FIG. 1.

FIG. 3 is a side schematic view of the baling machine of FIG. 1.

FIG. 4 is a side schematic view of a portion of the baling machine of FIG. 1.

FIG. 5 is a side schematic view of the baling machine of FIG. 1 during a baling cycle with an upper conveyor rake in a lowered position.

FIG. 6 is a side schematic view of the baling machine of FIG. 1 during a non-baling cycle with the upper conveyor rake in the lowered position.

FIG. 7 is a side schematic view of the baling machine of FIG. 1 during the non-baling cycle with the upper conveyor rake in a raised position.

FIG. 8 is a side schematic view of the baling machine of FIG. 1 during the non-baling cycle with the upper conveyor rake in another raised position.

FIG. 9 is a side schematic view of the baling machine of FIG. 1 during the baling cycle with the upper conveyor rake in the raised position.

FIG. 10 is a side schematic view of the baling machine of FIG. 1 having a biasing member attached to the upper conveyor rake.

FIG. 11 is a side schematic view of the baling machine of FIG. 1 having another biasing member attached to the upper conveyor rake.

FIG. 12 is a side schematic view of the baling machine of FIG. 1 having an alternative upper conveyor rake, according to one example of the present disclosure.

FIG. 13 is a side schematic view of a portion the baling machine of FIG. 1 having a plurality of drop pans, according to one example of the present disclosure.

FIG. 14 is a side schematic view of a portion the baling machine of FIG. 1 having a lower rake assembly drop pan, according to one example of the present disclosure.

FIG. 15 is a side schematic view of a portion the baling machine of FIG. 1 having a lower rotor rake drop pan, according to one example of the present disclosure.

FIG. 16 is a side schematic view of a portion the baling machine of FIG. 1 having a drop pan arrangement, according to one example of the present disclosure.

FIG. 17 is a side schematic view of the drop pan arrangement of FIG. 16 with the drop pan arrangement partially lowered.

FIG. 18 is a side schematic view of the drop pan arrangement of FIG. 16 with the drop pan arrangement completely lowered.

FIG. 19 is a side schematic view of a portion the baling machine of FIG. 1 having a drop pan arrangement, according to one example of the present disclosure.

FIG. 20 is a side schematic view of the drop pan arrangement of FIG. 19 with the drop pan arrangement partially lowered.

FIG. 21 is a side schematic view of a portion the baling machine of FIG. 1 having a movable upper rotor, according to one example of the present disclosure.

FIG. 22 is a schematic illustration of a driveline arrangement of the baling machine of FIG. 1, according to one example of the present disclosure.

FIG. 23 is a schematic top view of the baling machine of FIG. 1, according to one example of the present disclosure.

Corresponding reference characters indicate corresponding parts throughout the several views. The exemplifications set out herein illustrate an embodiment of the invention, and such exemplifications are not to be construed as limiting the scope of the invention in any manner.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

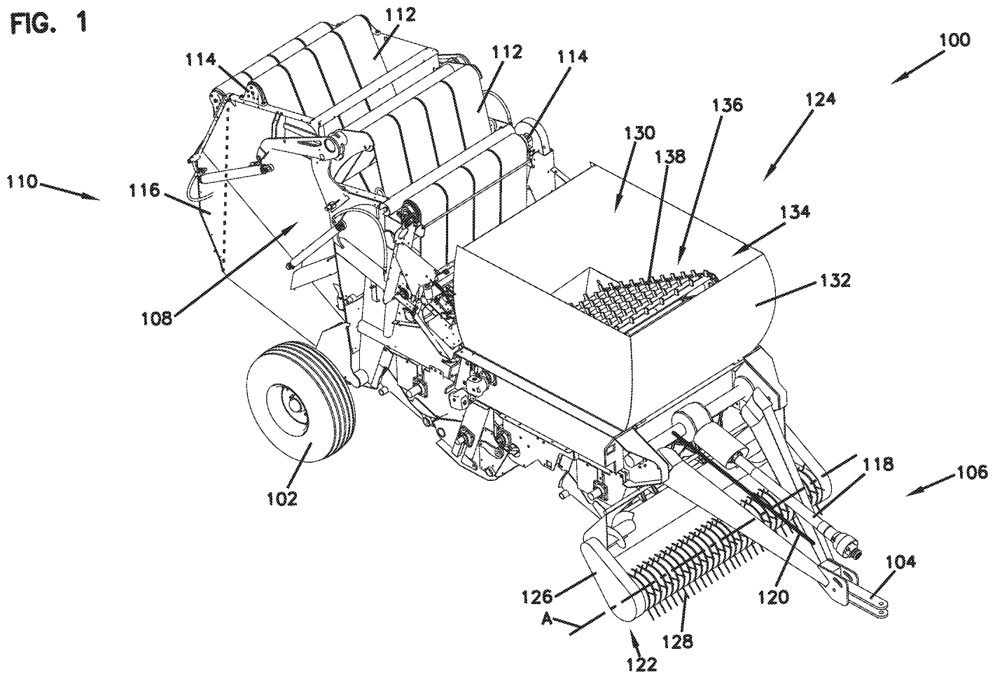

FIG. 1 shows a perspective side view of a baling machine 100. The baling machine 100 is configured to form and then eject bales formed from loose material picked up by the baling machine 100. The baling machine 100 is configured to be operated in a continuous manner without needing to stop to form or eject bales. An example continuous baling machine is disclosed in PCT Serial No. PCT/CA2017/051031 for a “CONTINUOUS ROUND BALER AND IMPROVED METHOD OF ROUND BALE FORMATION,” which is hereby incorporated by reference in its entirety.

The baling machine 100 is configured to form round bales. Bales can be formed from a variety of different material and can be a variety of different sizes. For example, forage or cut crop material can be formed into the bales by the baling machine 100. Crop/forage material can include, but is not limited to, straw, hay, grasses, oats, corn stalks, and the like suitable for baling. Further, depending on the type of bale to be formed, the crop/forage material can be baled either after drying or when the crop/forage material is still damp with moisture.

The baling machine 100 can be towed behind a vehicle (e.g., a tractor) via wheels 102 and a hitch mount 104 positioned at a forward end 106 of the baling machine 100. In some examples, the baling machine 100 can be operated as a standalone machine.

In one example, the baling machine 100 uses a baling chamber 108 that is expandable, generally located at a rearward end 110 of the baling machine 100. The baling chamber 108 operates by utilizing at least one bale forming belt 112 routed around a series of rollers 114. As material is deposited in the baling chamber 108, the material is compressed by the tensioned bale forming belt 112. In some examples, the baling machine 100 uses a fixed volume baling chamber. Once a full bale is formed, the bale is ejected from the baling chamber 108 via a rear lift gate 116 at the rearward end 110. Further details relating to a baling operation within a baling chamber can be found in U.S. Pat. Nos. 7,181,900 and 7,395,756, which are both hereby incorporated by reference in their entirety.

The baling machine 100 includes a mechanical power input 118 (e.g. a PTO shaft) for powering the operation of certain components of the baling machine 100. The mechanical power input 118 can be powered by a tow vehicle, such as a tractor. The baling machine 100 can also include a hydraulic power input 120 that is configured to be powered by the tow vehicle. The tow vehicle is configured to provide pressurized fluid flow via the hydraulic power input 120 to operate certain components of the baling machine 100.

The baling machine 100 also includes an infeed assembly 122 and an accumulator 124. Generally, first material is picked up by the infeed assembly 122 at the forward end 106 of the baling machine. Material is then transferred into the accumulator 124, and then material is passed from the accumulator 124 to the baling chamber 108 where a bale is formed. Once a bale is formed, the bale is ejected from the baling chamber 108 as the baling machine 100 is moving and as material is continuously fed into the accumulator 124 by the infeed assembly 122. This allows the baling machine 100 to be continuously picking up material as the baling machine 100 is moving, thereby leading to faster more efficient operation than traditional baling machines.

The infeed assembly 122 includes a pick-up device 126 that is configured to rotate about a pick-up device axis A as the baling machine 100 is moving. In some examples, the pick-up device 126 can include a plurality of tines 128 that are configured to aid in picking up the loose material from a ground surface. In some examples, the pick-up device can be a traditional cam style pick-up. In some examples, the pick-up device can be a cam-less style pick-up. Further details relating to a pick-up device can be found in U.S. Pat. Nos. 6,948,300 and 7,204,074, which are both hereby incorporated by reference in their entirety. In the depicted example, loose material is transferred into the accumulator 124 via the infeed assembly 122 in a generally upward direction.

The accumulator 124 is configured to receive picked up material from the infeed assembly 122 and pass the material to the baling chamber 108 for baling. The accumulator 124 includes an accumulator chamber 130 that has an internal volume at least partially defined by a housing 132. In some examples, the housing 132 includes a plurality of walls. In the depicted example, the accumulator chamber 130 includes an open top side 134. In some examples, the top side 134 can be enclosed. In other examples, the top side 134 can include a hood or other like structure to selectively open the top side 134.

The accumulator chamber 130, as will be discussed in detail herein, is configured to temporarily hold loose material before transferring that material to the baling chamber 108. In some examples, the accumulator chamber 130 includes a plurality of raking assemblies positioned at least partially within the internal volume of the accumulator chamber 130. The raking assemblies are configured to move material positioned within the accumulator chamber 130 toward the baling chamber 108. Specifically, as shown in FIG. 1, the accumulator 124 includes an upper rake assembly 136 that includes an upper conveyor rake 138 that is at least partially positionable and movable within the internal volume of the accumulator chamber 130.

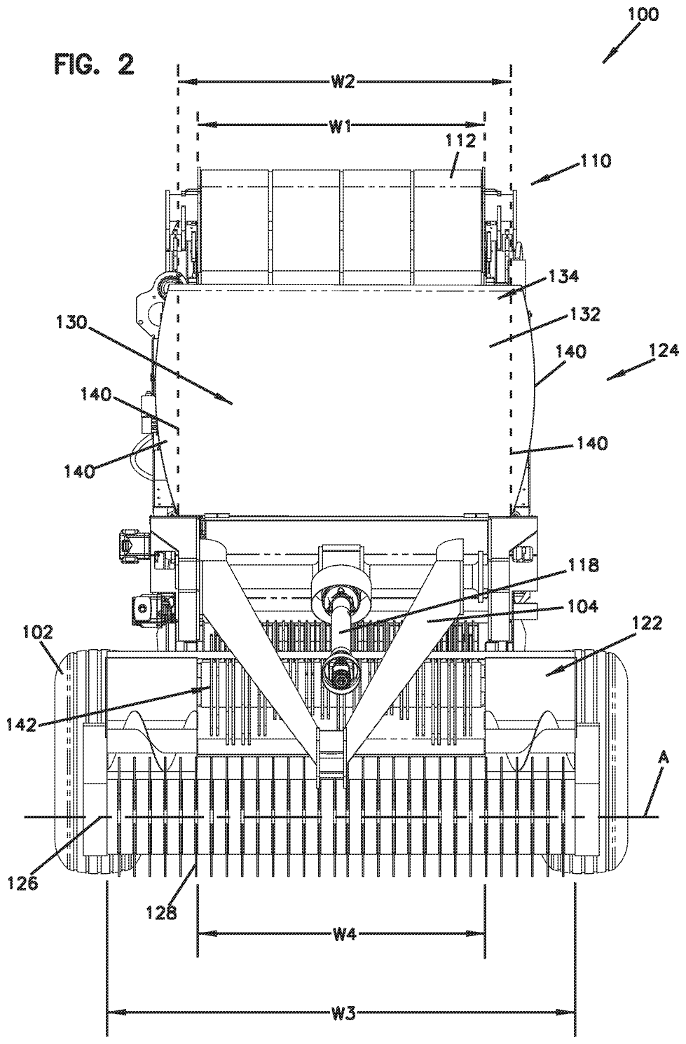

FIG. 2 shows a front view of the baling machine 100. The baling chamber 108 has a width W1, the accumulator chamber 130 of accumulator 124 has a width W2, and the pick-up device 126 of the infeed assembly 122 has a width W3. In some examples, the widths W1, W2, W3 are not equal. In some examples, the widths W1, W2, W3 are equal.

The width W1 of the baling chamber 108 can vary based on the size of bale that is intended to be produced. In some examples, the width W1 of the baling chamber 108 can be about 4 feet wide. In other examples, the width W1 of the baling chamber 108 can be about 5 feet wide.

The width W2 of the accumulator chamber 130 can also vary based on the size of the baling chamber 108. In some examples, the width W2 of the accumulator chamber 130 is greater than about 4 feet. In some examples, the width W2 of the accumulator chamber 130 is greater than about 5 feet. In some examples, the housing 132 of the accumulator chamber 130 has generally straight sidewalls 140, as shown by phantom lines in FIG. 2. In other examples, the sidewalls 140 can be curved inward or outward. In some examples, the width W2 of the accumulator chamber 130 is greater than the width W1 of the baling chamber 108.

The width W3 of the pick-up device can also be altered based on particular conditions. For example, if a wider pile of loose material (i.e., a windrow) is intended to be baled, the pick-up device 126 having the associated width can be used. In some examples, the width W3 of the pick-up device 126 is greater than both the width W2 of the accumulator chamber 130 and the width W1 of the baling chamber 108.

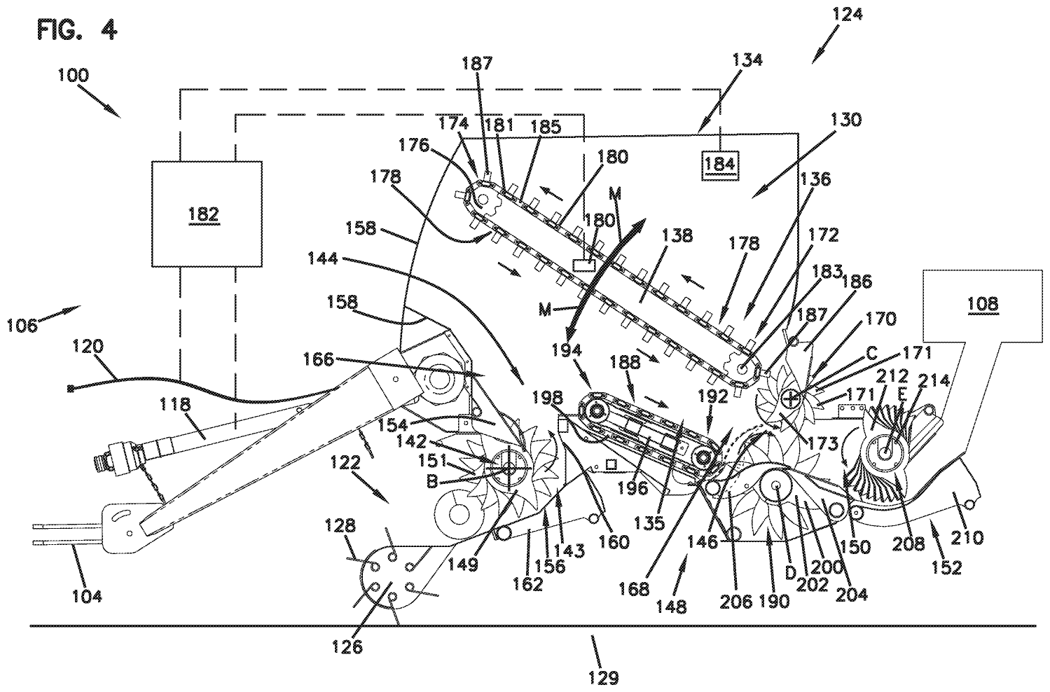

In the depicted example, the infeed assembly 122 can include an infeed rotor 142 that is configured to receive the material from the pick-up device 126 and pass the material into the accumulator chamber 130. In some examples, the infeed rotor 142 can aid in performing a cutting action with a stationary knife section to reduce the size of the material entering the accumulator 124. In some examples, the infeed rotor has a width W4 that is less than or equal to the width W3 of the pick-up device 126. In some examples, the width W4 of the infeed rotor 142 is also less than the width W2 of the accumulator chamber 130. The infeed rotor 142 will be discussed in more detail herein with respect to FIG. 4

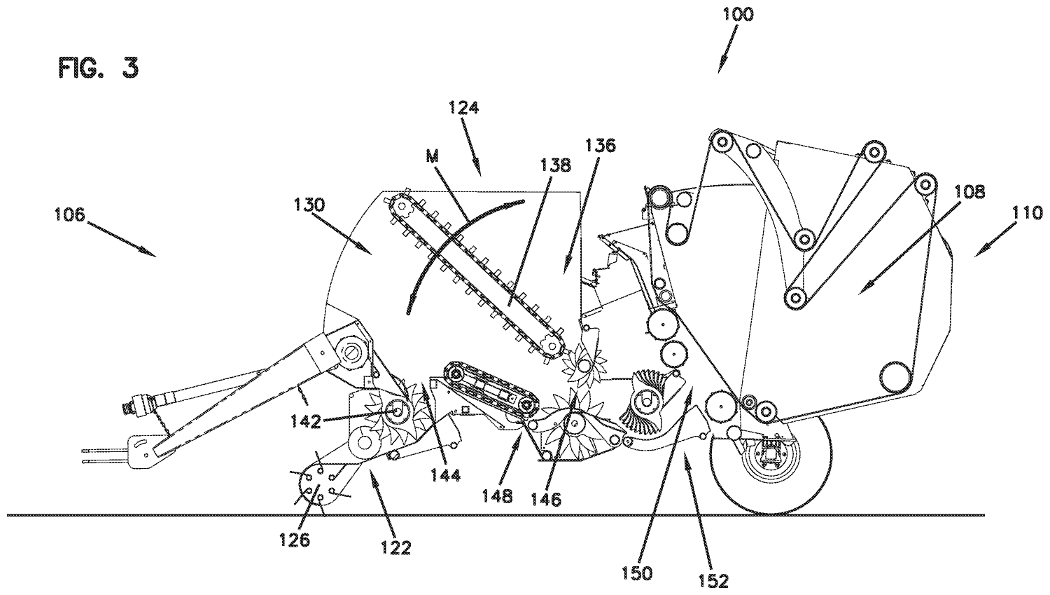

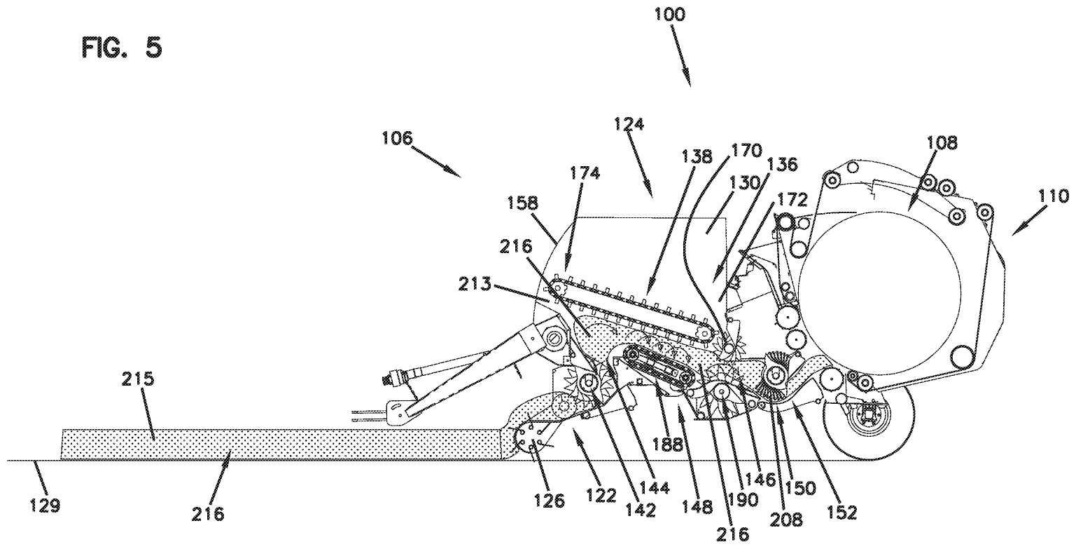

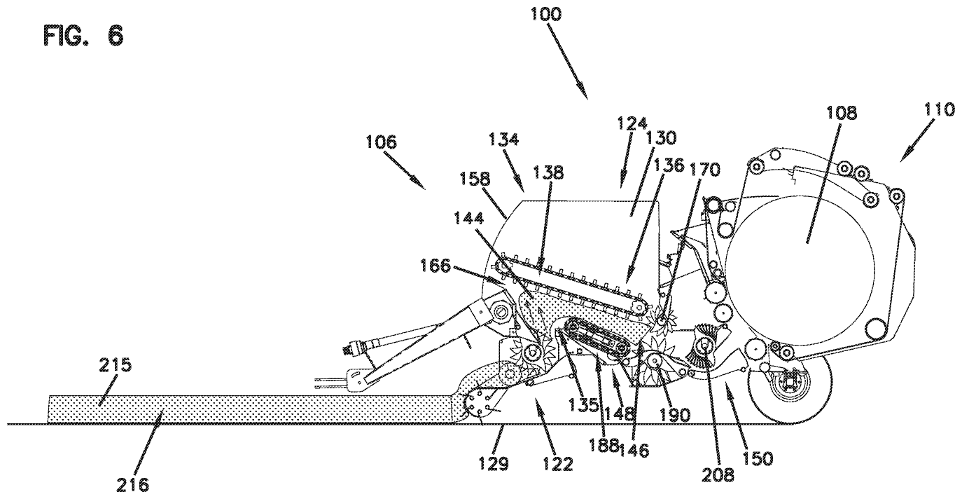

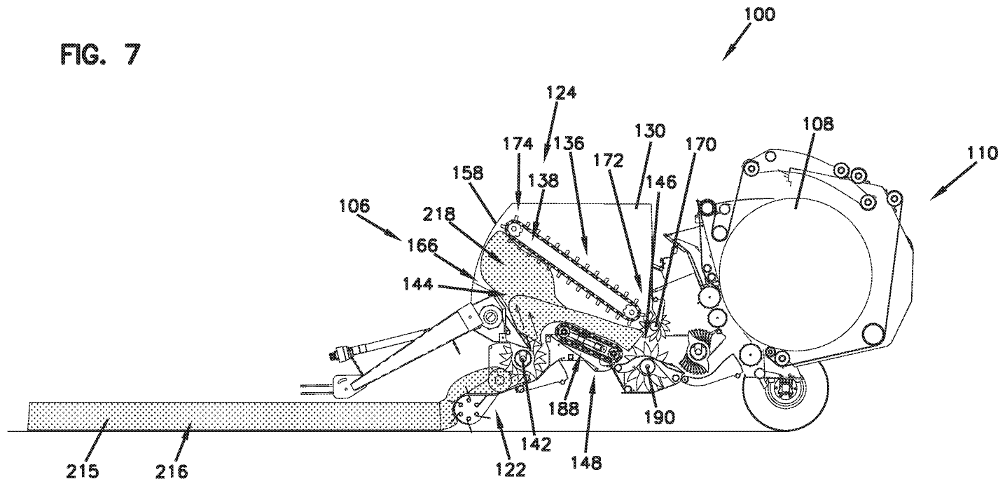

FIG. 3 shows a schematic side view of the baling machine 100. The infeed assembly 122 is shown to include the pick-up device 126 and the infeed rotor 142. The accumulator 124 is shown to include the accumulator chamber 130, having an inlet 144, and an outlet 146 (e.g., an exit slot); the upper rake assembly 136; and a lower rake assembly 148. The baling chamber 108 is shown to include an inlet 150 and an inlet assembly 152 disposed within the inlet 150. As described further herein, the upper conveyor rake 138 is movable within the accumulator chamber 130 and has a range of motion M between a lowered position (shown in FIG. 5-6) and a raised position (shown in FIGS. 7-9). In some examples, the upper conveyor rake 138 can have a plurality of raised positions.

FIG. 4 shows a schematic side view of a portion of the baling machine 100. The baling chamber 108 and baling chamber inlet 150 are shown schematically.

The infeed assembly 122 is configured to pass material in an upward direction from a ground surface 129, through an outlet 143 of the infeed assembly 122, and into the inlet 144 of the accumulator chamber 130. The pick-up device 126 transfers material to the infeed rotor 142 and the infeed rotor 142 then transfers material through the outlet 143 of the infeed assembly 122.

The infeed rotor 142 can include a plurality of teeth 151 spaced across the width W4 of the infeed rotor 142. In some examples, the infeed rotor 142 can include a pair of teeth 151 spaced generally 180 degrees apart from one another on a single plate 149 from an infeed rotor axis B. In some examples, the infeed rotor 142 can include four teeth 151 are spaced generally 90 degrees apart from one another on a single plate 149 from an infeed rotor axis B. In other examples, the infeed rotor 142 can include a plurality of teeth 151 are spaced apart from one another on a single plate 149. In the depicted example, the infeed rotor 142 includes a plurality of plates 149. In some examples, the infeed rotor 142 includes more than two teeth 151 per plate 149. In other examples, the infeed rotor 142 includes less than two teeth 151 per plate 149.

In some examples, the teeth 151 operate to grab material from the pick-up device 126 and move the material though the outlet 143 of the infeed assembly 122 and toward the inlet 144 of the accumulator 124. In the depicted example, the infeed rotor 142 is configured to rotate about the axis B in a direction toward the inlet 144 of the accumulator chamber 130. In some examples, the teeth 151 of the infeed rotor 142 have a swept back configuration that lean in the opposite direction of rotation of the infeed rotor 142. In some examples, the teeth 151 function to break up the material to reduce the instance of material plugs/clumps. In some examples, the rotation of the infeed rotor 142 is powered by a hydraulic motor powered by the hydraulic power input 120 and/or via a mechanical drive powered by the mechanical power input 118.

In some examples, the plates 149 of the infeed rotor 142 can be positioned along the length of the axis B so that the teeth 151 form a spiral pattern along the longitudinal width of the infeed rotor 142. In some examples, the teeth 151 can spiral from one end of the infeed rotor 142 to the other. In other examples, the teeth 151 can spiral outwards from the center toward each end of the infeed rotor 142 to force material outwardly from the center of the infeed rotor 142.

The outlet 143 of the infeed assembly includes an infeed material stripper device 154 and a guide 156. The guide 156 generally slopes upwardly from the ground surface 129 toward the inlet 144 of the accumulator 124. The guide 156 is configured to direct material that is transferred into the outlet 143 by the infeed rotor 142 upwardly.

The infeed material stripper device 154 is positioned adjacent the infeed rotor 142. In the depicted example, the infeed material stripper device 154 is positioned at a top side of the infeed rotor 142, generally closer to the inlet 144 of the accumulator chamber 130 than the infeed rotor 142. The infeed material stripper device 154 is configured to strip material from the teeth 151 of the infeed rotor 142 to aid in preventing the binding of material around the infeed rotor 142. In some examples, the infeed material stripper device 154 can be configured to include a plurality of slots that are each positioned to allow a single tooth 151 of the infeed rotor 142 to pass through. In the depicted example, due to the swept back configuration of the teeth 151 of the infeed rotor 142, material is slid from the teeth 151 by the infeed material stripper device 154 as the teeth 151 rotate past the infeed material stripper device 154. Due to the positioning of the infeed material stripper device 154 above the infeed rotor 142 and adjacent the inlet 144 of the accumulator chamber 130, as material is stripped from the teeth 151 of the infeed rotor 142, the stripped material continues in an upward direction, through the inlet 144 and into the accumulator chamber 130.

In the depicted example, the guide 156 is positioned below and next to the infeed rotor 142. In some examples, the guide 156 extends the entire longitudinal width W4 of the infeed rotor 142. In some examples, the guide 156 is configured to direct material through the outlet 143 of the infeed assembly 122 in a direction toward a front wall 158 of the accumulator chamber 130 as the material passes through the inlet 144 of the accumulator 124. In some examples, the guide 156 includes a portion 160 that is sloped toward the forward end 106 of the baling machine in the direction of material flow through the outlet 143.

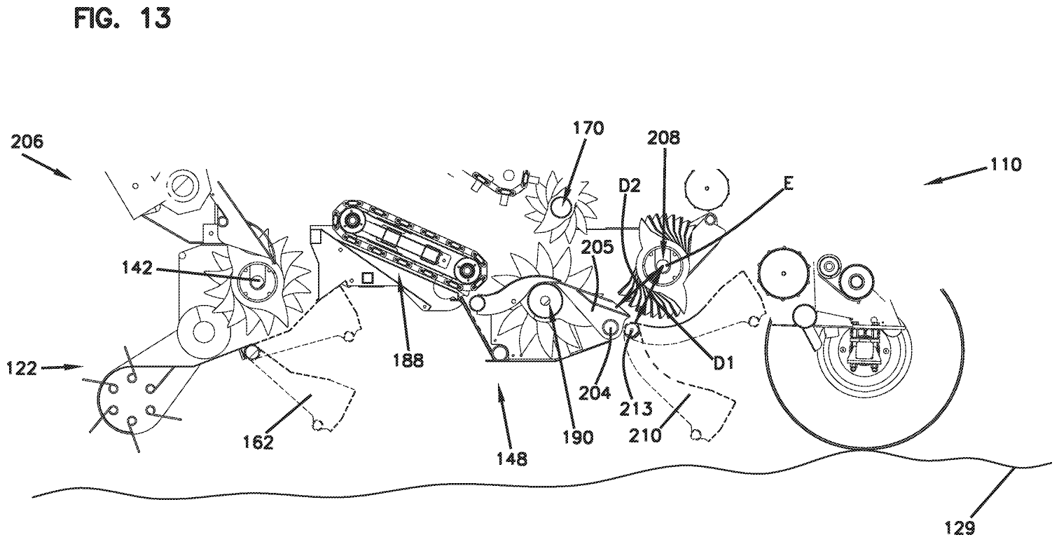

In some examples, the guide 156 can include an infeed drop pan 162 that is configured to be selectively moved in a direction away from the infeed rotor 142 to clear debris from the infeed outlet 143 and generally allow access to the infeed rotor 142. The infeed drop pan 162 will be described in more detail with respect to FIG. 13.

In the depicted example, the inlet 144 of the accumulator 124 is positioned at a bottom side 135 of the accumulator chamber 130. Further, as shown, the inlet 144 is positioned at a front side 166 of the bottom side 135 of the accumulator chamber 130. Such positioning allows material to flow upward into the accumulator chamber 130 in a tumbling, swirling, and stirring action.

Further, in some examples, the front wall 158 of the accumulator chamber 130 slopes upward and toward the forward end 106 of the baling machine 100 as the front wall 158 extends from the bottom side 135 of the accumulator chamber 130 toward the top side 134. As the front wall 158 continues to extend toward the top side 134, the front wall 158 changes direction to slope upward and toward the rearward end 110 of the baling machine 100. In such an example, the change of direction of the front wall 158, combined within the inlet 144 being positioned at the front side 166 of the bottom side 135 of the accumulator chamber 130 forces material to tumble, swirl, and stir as the material enters the accumulator chamber 130.

The outlet 146 of the accumulator 124 is positioned opposite of the inlet 144, at a back side 168 of the bottom side 135 of the accumulator chamber 130. In some examples, the outlet 146 is positioned at the bottom side 135 closer to the ground 129 than the inlet 144. In some examples, the accumulator chamber 130 has a configuration that generally slopes downward from the inlet 144 to the outlet 146. In some examples, the outlet 146 is defined by the lower rake assembly 148 and the upper rake assembly 136. Material that passes through the outlet 146 is sifted, stirred, and/or torn apart by the lower rake assembly 148 and the upper rake assembly 136. In some examples, the sifting, stirring, and/or tearing is configured to deliver material to the baling chamber 108 in a uniform manner to simulate an ideal windrow of material. In some examples, the size of the outlet 146 can be selectively altered by moving components of the lower rake assembly 148 and/or the upper rake assembly 136. Altering the size of the outlet 146 can be advantageous with baling certain crop material and/or to aid in reducing unwanted plugs of material within the accumulator chamber 130. The outlet 146 is positioned directly adjacent the inlet assembly 152 of the baling chamber 108.

The upper rake assembly 136 is configured to move material within the accumulator chamber 130 from the inlet 144 toward the outlet 146. In some examples, the upper rake assembly 136 moves material partially in a downward direction toward the outlet 146. The upper rake assembly 136 includes the upper conveyor rake 138 and an upper rotor rake 170. In some examples, the upper conveyor rake 138 and the upper rotor rake 170 are both selectively powered so that they can be rotated to move material toward the outlet 146 from the accumulator chamber 130.

The upper conveyor rake 138 includes a first end 172 and a second end 174. In some examples, the first end 172 is closer to the lower rake assembly 148 than the second end 174 through the majority of a range of motion M of the upper conveyor rake 138. In some examples, the first end 172 is closer to the bottom side 135 of the accumulator chamber 130 than the second end 174 through the majority of the range of motion M of the upper conveyor rake 138. In some examples, the first end 172 is pivotally fixed to the accumulator chamber 130 so that as the upper conveyor rake 138 moves through the range of motion M, the upper conveyor rake 138 rotates about the first end 172. In some examples, the second end 174 has a greater range of motion as the upper conveyor rake 138 moves through the range of motion M than the first end 172. In some examples, the first end 172 is not fixed to the accumulator chamber 130.

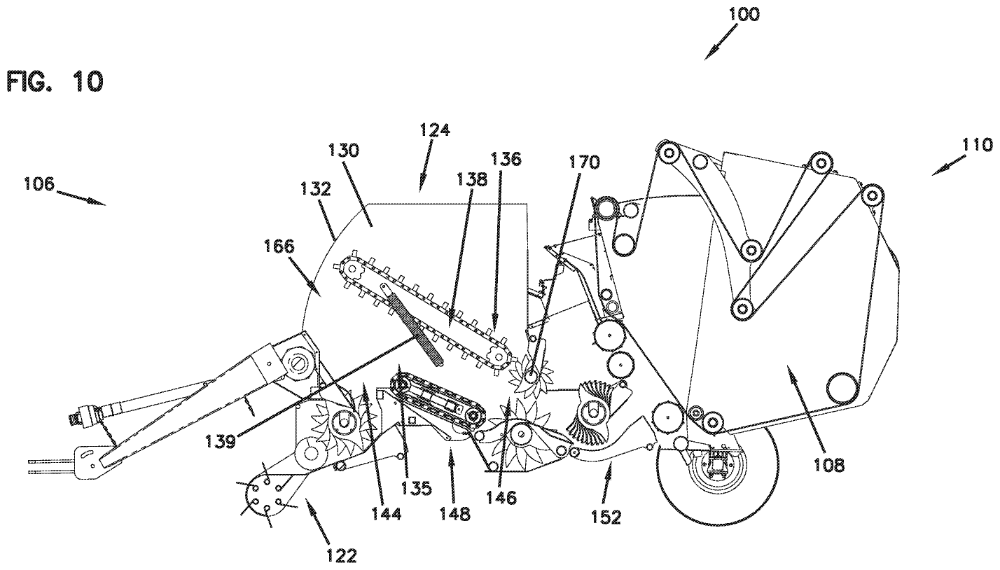

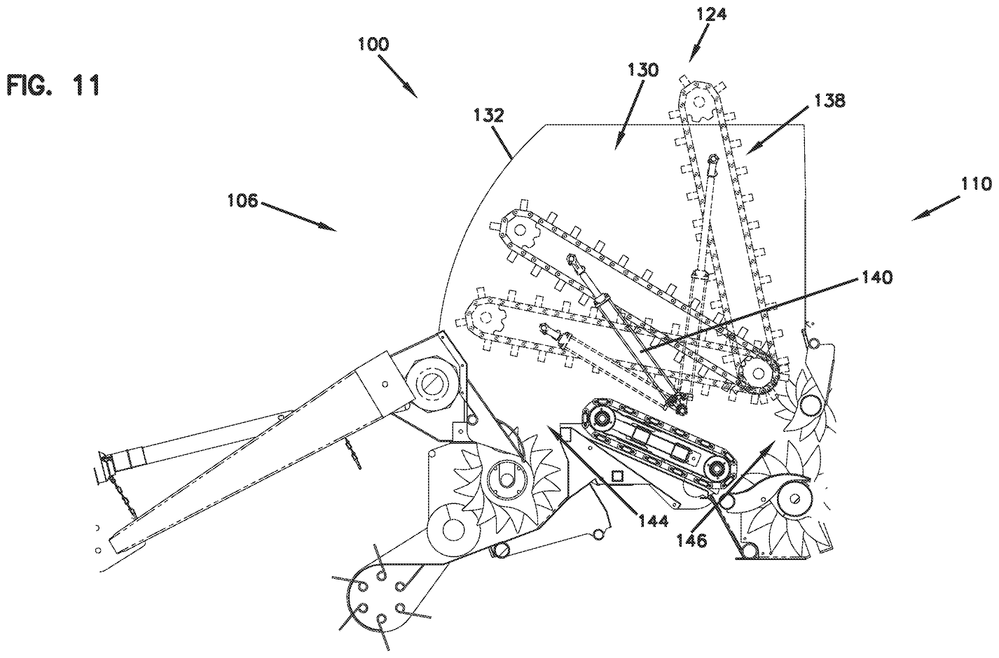

In some examples, the upper conveyor rake 138 floats within the accumulator chamber 130 as material enters via the inlet 144 and exits via the outlet 146 of the accumulator chamber 130. In some examples, the upper conveyor rake 138 is biased toward the lower rake assembly 148 and the bottom side 135 of the accumulator chamber 130 by way of gravity. In some examples, the upper conveyor rake 138 is configured to be positioned at least partially above the inlet 144 within the range of motion M. In some examples, as material enters the accumulator chamber 130 at the inlet 144, the material pushes the upper conveyor rake 138 in a direction away from the inlet 144. As material leaves the accumulator chamber 130, the upper conveyor rake 138 can move in a direction back toward the inlet 144. In some examples, movement of the upper conveyor rake 138 can be powered or biased by way of a spring, actuator, or other similar device, as is shown in FIGS. 10-11. In other examples, movement of the upper conveyor rake 138 can be selectively limited to just a portion of the range of motion M. Movement of the upper conveyor rake 138 during operation of the baling machine 100 will be discussed in more detail herein with respect to FIGS. 5-9.

The upper conveyor rake 138 includes an upper conveyor frame 176 and an upper conveyor body 178 that is rotatable about the frame 176. In some examples, the conveyor body 178 is rotatable about the frame at a variable number of speeds. In some examples, the conveyor body 178 can utilize a plurality of slats 181 fixed to a plurality of chains 185 (or other like device). In some examples, the slats 181 include teeth 187 extending from each slat 181 to grasp, tear, sift, and/or stir material as the conveyor body 178 is rotated about the frame 176. In other examples, the conveyor body 178 is a belt. In other examples still, the conveyor body 178 includes a plurality of rollers.

The conveyor body 178 is configured to rotate about the frame 176 in either a direction away from the outlet 146 or a direction toward the outlet 146. As indicated by movement arrows in the depicted example, during normal operation, the conveyor body 178 rotates about the frame 176 in a direction toward the outlet 146. In some examples, the conveyor body 178 can temporarily rotate away from the outlet 146 if an unwanted plug of material were to form within the accumulator chamber 130. Such reversed movement of the conveyor body 178 can either be automatically performed by the baling machine 100 or manually performed by an operator.

In some examples, the upper conveyor rake 138 can include a sensor 180 mounted thereto. In some examples, the sensor 180 is in communication with a control system 182. The sensor 180 can sense at least one of a position, a speed, and a load of the upper conveyor rake 138. In some examples, the sensor 180 can be a variety of different types of sensors, including but not limited to, a pressure transducer, accelerometer, gyroscope, etc. In some examples, the upper conveyor rake 138 can include a plurality of sensors.

In other examples, the accumulator 124 can include an additional sensor 184, instead of, or in addition to, the sensor 180. In some examples, the accumulator 124 can include a plurality of additional sensors 184. The sensor 184 can be mounted within the accumulator chamber 130 or in communication with a driving input (e.g., a drive shaft 183 at the first end 172) for driving the rotation or movement of the upper conveyor rake 138. The additional sensor 184 can be configured to monitor the behavior of the upper conveyor rake 138. In some examples, the additional sensor 184 can be one of a variety of different types of sensors, including but not limited to, an optical sensor, a proximity sensor, a speed sensor, and/or a camera. In some examples, when the sensor 184 is a camera, a live feed from the camera can be broadcast to the operator in the tow vehicle.

The control system 182 can be in communication with the sensor 180 and/or sensor 184 to receive a signal therefrom. In some examples, the control system 182 can use signals received from the sensors 180, 184 to control the operation of the baling machine 100. In some examples, the control system 182 operates the baling machine 100 independent of sensor feedback. In some examples, the control system 182 can change the operating behavior of components of the baling machine 100 by altering the power provided from the towing vehicle to the mechanical power input 118 and/or the hydraulic power input 120 of the baling machine 100.

The control system 182 can control the operation of the infeed assembly 122, upper rake assembly 136, lower rake assembly 148, and/or the inlet assembly 152 of the baling chamber 108. In some examples, the control system 182 can control the baling machine 100 automatically in response to signals received by the sensors 180, 184. For example, if the sensor 180 were to sense a high load encountered by the conveyor body 178, thereby indicating an unwanted plug of material within the accumulator chamber 130, the control system 182 could temporarily reverse the rotation of the conveyor body 178 about the frame 176 (i.e., change the direction of rotation to a direction away from the outlet 146) for a set time period in an attempt to break apart the unwanted plug. In other examples, the control system 182 is configured to control the speed of the upper conveyor rake 138 in response to the signals received from the sensors 180, 184. In other examples, the control system 182 is configured to control the position of the upper conveyor rake 138 within the accumulator chamber 130 in response to the signals received from the sensors 180, 184.

In other examples, the control system 182 allows the operator to control the baling machine 100 manually in response to the signals received from the sensors 180, 184. In some examples, the control system 182 alerts the operator when certain events occur (e.g., a threshold is exceeded) based on feedback from the sensors 180, 184.

In some examples, the control system 182 includes a processing unit operable to execute a plurality of software instructions that, when executed by the processing unit, cause the baling machine to implement the methods and otherwise operate and have functionality as described herein. The processing unit may comprise a device commonly referred to as a microprocessor, central processing unit (CPU), digital signal processor (DSP), or other similar device and may be embodied as a standalone unit or as a device shared with other components of the baling machine 100. The processing unit may include memory for storing the software instructions, or the system may further comprise a separate memory device for storing the software instructions that is electrically connected to the processing unit for the bi-directional communication of the instructions, data, and signals therebetween.

The upper rotor rake 170 is configured to be positioned adjacent the first end 172 of the upper conveyor rake 138 and closer to the outlet 146 than the upper conveyor rake 138. The upper rotor rake 170 is configured to be rotated about an axis C in a direction toward the outlet 146. In some examples, the upper rotor rake 170 is configured to at least partially define an upper boundary of the outlet 146. Rotation of the upper rotor rake 170 can be driven with, or separately from, rotation of the upper conveyor body 178 of the upper conveyor rake 138. In some examples, the upper rotor rake 170 is rotated by a hydraulic motor powered by the hydraulic power input 120 and/or via a mechanical drive powered by the mechanical power input 118. For example, a single chain drive can drive the rotation of both the upper rotor rake 170 and the upper conveyor body 178. In some examples, separate driving means can be utilized to drive the rotation of both the upper rotor rake 170 and the upper conveyor body 178 thereby facilitating separate rotational control of the upper rake assembly 136. In some examples, the upper rotor rake 170 operates at a faster tip speed than the upper conveyor rake 138. In some examples, the upper rotor rake 170 operates at least twice the tip speed of the upper conveyor rake 138.

Similar to the infeed rotor 142 described above, the upper rotor rake 170 can include a plurality of teeth 171 spaced across the longitudinal width of the upper rotor rake 170. In some examples, the upper rotor rake 170 can include a pair of teeth 171 spaced 180 degrees apart from the axis C and positioned on a single plate 173. In some examples, the upper rotor rake 170 can include four teeth 171 are spaced generally 90 degrees apart from one another on a single plate 173. In other examples, the upper rotor rake 170 can include a plurality of teeth 171 are spaced apart from one another on a single plate 173. In the depicted example, the upper rotor rake 170 includes a plurality of plates 173. In some examples, the upper rotor rake 170 includes more than two teeth 171 per plate 173. In other examples, the upper rotor rake 170 includes less than two teeth 171 per plate 173. In some examples, the teeth 171 operate to grab, tear, sift, and/or stir material as the material moves through the outlet 146 of the accumulator 124. In some examples, the teeth 171 have a swept back configuration that lean in the opposite direction of rotation of the upper rotor rake 170. In some examples, the teeth 171 function to break up the material to reduce the instance of material plugs/clumps.

In some examples, the teeth 171 of the upper rotor rake 170 overlap with the teeth 187 of the conveyor body 178 of the upper conveyor rake 138. In such an example, the teeth 171 of the upper rotor rake 170 are configured to strip material from the conveyor body 178 to aid in preventing unwanted wrapping of the material around the first end 172 of the upper conveyor rake 138.

The plates 173 can be positioned along the longitudinal length of the upper rotor rake 170 so that the teeth 171 form a spiral pattern along the longitudinal width of the upper rotor rake 170. In some examples, the teeth 171 can spiral from one end of the upper rotor rake 170 to the other. In other examples, the teeth 171 can spiral outwards from the center toward each end of the upper rotor rake 170 to force material outwardly from the center of the upper rotor rake 170.

An upper rotor rake material stripper device 186 is positioned adjacent the upper rotor rake 170. In the depicted example, the stripper device 186 is positioned at a top side of the upper rotor rake 170. The stripper device 186 is configured to strip material from the teeth 171 of the upper rotor rake 170 to aid in preventing the binding of material around the upper rotor rake 170. In some examples, like the infeed material stripper device 154, stripper device 186 can be configured to include a plurality of slots that are each positioned to allow a single tooth 171 of the upper rotor rake 170 to pass through. In the depicted example, due to the swept back configuration of the teeth 171 of the upper rotor rake 170, material is slid from the teeth 171 by the stripper device 186 as the teeth 171 rotate past the stripper device 186.

The lower rake assembly 148 is configured to move material in a direction toward the outlet 146. In some examples, the lower rake assembly 148 is configured to move material in a partially downward direction toward the outlet 146. In the depicted example, the lower rake assembly 148 includes a lower conveyor rake 188 and a lower rotor rake 190.

The lower conveyor rake 188 includes a first end 192 and a second end 194. In the depicted example, the lower conveyor rake 188 is sloped downwards from the second end 194 to the first end 192. In some examples, the first end 192 is adjacent the lower rotor rake 190 and the second end 194 is adjacent the inlet 144 of the accumulator chamber 130.

Like the upper conveyor rake 138, the lower conveyor rake 188 includes a lower conveyor frame 196 and a lower conveyor body 198 that is rotatable about the frame 196. In some examples, the conveyor body 198 can utilize a plurality of slats fixed to a plurality of chains (or other like device). In some examples, the slats include teeth extending from each slat to grasp material as the conveyor body 198 is rotated about the frame 196. The teeth can be configured to grab, tear, sift, and/or stir the material. In other examples, the conveyor body 198 is a belt. In other examples, the conveyor body 198 includes a plurality of rollers. The conveyor body 198 is configured to rotate about the frame 196 in either a direction away from the outlet 146 or in a direction toward the outlet. As indicated by movement arrows in the depicted examples, during normal operation, the conveyor body 198 rotates about the frame 196 in a direction toward the outlet 146.

In some examples, the conveyor body 198 is rotated by a hydraulic motor powered by the hydraulic power input 120 and/or via a mechanical drive powered by the mechanical power input 118. In some examples, rotation of the conveyor body 198 can be controlled separate from other components of the baling machine 100. In some examples, during normal operation, the conveyor body 198 of the lower conveyor rake 188 is rotated about the frame 196 at a speed slower than the tip speed of the conveyor body 178 about the frame 176 of the upper conveyor rake 138. In some examples, the conveyor body 198 of the lower conveyor rake 188 is rotated at about half the tip speed of the conveyor body 178 about the frame 176 of the upper conveyor rake 138. In some examples, the conveyor body 198 of the lower conveyor rake 188 is rotated at a slower tip speed than the conveyor body 178 of the upper conveyor rake 138, the upper rotor rake 170, the lower rotor rake 190, and the baler inlet rotor 208.

The lower rotor rake 190 is configured to be rotated about an axis D in a direction toward the outlet 146. In some examples, the lower rotor rake 190 is configured to be an overshot rotor that conveys material over the top of the rotor. In some examples, the lower rotor rake 190 is configured to at least partially define a lower boundary of the outlet 146. The lower rotor rake 190 is similar to the infeed rotor 142 and the upper rotor rake 170 in that it includes a plurality of teeth 200 rotatable about a central axis D. In some examples, a pair of teeth 200 are positioned on a plate 202 generally 180 degrees apart from another about the axis D. In some examples, the lower rotor rake 190 can include four teeth 200 are spaced generally 90 degrees apart from one another on a single plate 202. In other examples, the upper rotor rake 170 can include a plurality of teeth 171 are spaced apart from one another on the single plate 173. In the depicted example, the lower rotor rake 190 includes a plurality of plates 202. In some examples, the lower rotor rake 190 includes more than two teeth 200 per plate 202. In other examples, the lower rotor rake 190 includes less than two teeth 200 per plate 202. The teeth 200 operate to grab, tear, sift, and/or stir material as the material moves through the outlet 146 of the accumulator 124. In some examples, the teeth 200 have a swept back configuration that lean in the opposite direction of rotation of the lower rotor rake 190. In some examples, the teeth 200 function to break up the material to reduce the instance of material plugs/clumps. In some examples, the teeth 171 operate to grab, tear, sift, and/or stir material as the material moves through the outlet 146 of the accumulator 124.

In some examples, the plates 202 can be positioned along the longitudinal width of the lower rotor rake 190 so that the teeth 200 form a spiral pattern along the longitudinal width of the lower rotor rake 190. In some examples, the teeth 200 can spiral from one end of the lower rotor rake 190 to the other. In other examples, the teeth 200 can spiral outwards from the center toward each end of the lower rotor rake 190 to force material outwardly from the center of the lower rotor rake 190.

In some examples, the teeth 200 of the lower rotor rake 190 are positioned adjacent the first end 192 of the lower conveyor rake 188. In such an example, the teeth 200 of the lower rotor rake 190 are configured to strip material from the first end 192 to aid in preventing unwanted wrapping of the material around the lower conveyor rake 188.

In some examples, the teeth 200 do not overlap the teeth 171 of the upper rotor rake 170. In some examples, the teeth 171 of the upper rotor rake 170 and the teeth 200 of the lower rotor rake 190 are generally arranged in a tip-to-tip arrangement. In some examples, the teeth 200 of the lower rotor rake overlap and mesh with the teeth 171 of the upper rotor rake 170.

The lower rotor rake 190 is rotated by a hydraulic motor powered by the hydraulic power input 120 and/or via a mechanical drive powered by the mechanical power input 118. In some examples, rotation of the lower rotor rake 190 can be driven with, or separately from, rotation of the lower conveyor body 198 of the lower conveyor rake 188. In some examples, rotation of the lower rotor rake 190 can be driven with the rotation of the upper rotor rake 170.

For example, a single chain drive can drive the rotation of both the upper rotor rake 170 and the lower rotor rake 190. In some examples, the lower rotor rake 190 operates at a faster tip speed than the lower conveyor rake 188. In some examples, the lower rotor rake 190 operates during normal operation with a tip speed greater than the upper rotor rake 170. In some examples, the lower rotor rake 190 is rotated at a faster tip speed than the conveyor body 178 of the upper conveyor rake 138, the upper rotor rake 170, the lower rotor rake 190, and the conveyor body 198 of the lower conveyor rake 188.

In some examples, a lower rotor rake drop pan 191 is positioned below the lower rotor rake 190. Like the drop pan 162, the drop pan 191 can be selectively lowered toward the ground 129 to allow the clearing of any unwanted buildup of material near the lower rotor rake 190. In some examples, the drop pan 162 can include a plurality of knives to cut material as it passes through the infeed assembly 122.

A lower rotor rake material stripper device 204 is positioned adjacent the lower rotor rake 190. In the depicted example, the stripper device 204 is positioned between the lower rotor rake 190 and the inlet 150 of the baling chamber 108. The stripper device 204 is configured to strip material from the teeth 200 of the lower rotor rake 190 to aid in preventing the binding of material around the lower rotor rake 190. In some examples, like the infeed material stripper device 154 and the upper rotor rake material stripper device 186, stripper device 204 can be configured to include a plurality of slats that are each positioned to allow a single tooth 200 of the lower rotor rake 190 to pass through. In the depicted example, due to the swept back configuration of the teeth 200 of the lower rotor rake 190, material is slid from the teeth 200 by the stripper device 204 as the teeth 200 rotate past the stripper device 204.

The lower rake assembly 148 also includes a lower conveyor material stripper device 206 that is positioned between the lower conveyor rake 188 and the lower rotor rake 190. The stripper device 206 is configured to aid in preventing material from being wrapped around the lower conveyor rake 188 and/or the lower rotor rake 190. The stripper device 206 can be configured in a substantially similar way as the infeed material stripper device 154, upper rotor rake material stripper device 186, and the lower rotor rake material stripper device 204.

In some examples, the stripper device 206 is movable to temporality block the outlet 146 of the accumulator chamber 130. In some examples, this blocking can be done while the lower conveyor rake 188 continues to rotate. In some examples, this blocking can be done while the lower rotor rake 190 continues to rotate.

The inlet 150 of the baling chamber 108 is adjacent the outlet 146 of the accumulator chamber 130. Material flows from the outlet 146 and into the inlet 150 of the baling chamber 108. Positioned within the inlet 150 is the inlet assembly 152 that includes a baler inlet rotor 208 and a baler inlet rotor drop pan 210.

In some examples, the baler inlet rotor 208 is configured to be an undershot rotor that conveys material under the rotor. The baler inlet rotor 208, like the other rotor rakes 142, 170, 190 includes teeth 212 that rotate about an axis E. In the depicted example, a pair of teeth 212 are positioned 180 degrees apart from one another on a single plate 214. In some examples, the baler inlet rotor 208 can include four teeth 212 are spaced generally 90 degrees apart from one another on a single plate 214. In other examples, the baler inlet rotor 208 can include a plurality of teeth 212 are spaced apart from one another on the single plate 214. In the depicted example, the baler inlet rotor 208 includes a plurality of plates 214. In some examples, the baler inlet rotor 208 includes more than two teeth 212 per plate 214. In other examples, the baler inlet rotor 208 includes less than two teeth 212 per plate 214. In some examples, the plates 214 are positioned along the length of the axis E so that the teeth 212 form a spiral pattern along the longitudinal width of the baler inlet rotor 208. In some examples, the teeth 212 can spiral from one end of the baler inlet rotor 208 to the other. In other examples, the teeth 212 can spiral outwards toward each end from the center of the baler inlet rotor 208 to force material outwardly from the center of the baler inlet rotor 208. In some examples, the teeth 212 function to break up the material to reduce the instance of material plugs/clumps.

In some examples, the baler inlet rotor 208 operates at a faster tip speed than the lower rotor rake 190, upper rotor rake 170, lower conveyor rake 188, and upper conveyor rake 138.

The baler inlet rotor 208 is configured to rotate in a direction that pulls materials between the baler inlet rotor 208 and the baler inlet rotor drop pan 210. In some examples, the drop pan 210 can be selectively movable away from the baler inlet rotor 208 to allow unwanted plugs of material to clear, similar to drop pan 162. In some examples, the drop pan 210 can include a plurality of knives to cut material as it passes through the inlet 150.

During operation of the baling machine 100, the baling machine 100 has a baling cycle and a non-baling cycle. During the baling cycle, material is continuously fed into the baling chamber 108 to form a bale. Once a bale is fully formed, the baling machine 100 enters the non-baling cycle. In one example, during the non-baling cycle, the fully formed bale is wrapped with a material (e.g., netwrap, twine, plastic, etc.) within the baling chamber 108 to maintain the shape of the bale once the bale is ejected from the baling chamber 108. During the non-baling cycle, the accumulator 124 does not deliver material to baling chamber 108 but does however continue to accumulate material within the accumulator chamber 130.

To stop material flow into the baling chamber 108 during the non-baling cycle, rotation of at least the upper conveyor rake 138 and the lower conveyor rake 188 can be stopped. In some examples, the rotation of the upper and lower rotor rakes 170, 190 is also stopped during the non-baling cycle. In some examples, the lower conveyor material stripper device 206 can be moved to block the flow of material into the inlet 150 of the baling chamber during the non-baling cycle. In some examples, when the stripper device 206 is raised to block the outlet 146 and/or the inlet 150 of the baling chamber 108, the lower conveyor rake 188 can continue to rotate.

As mentioned above, the rotational components of the upper and lower rake assemblies 136, 148 have different operational tip speeds. This stepped-speed configuration is important to the flow of material from the inlet 144 to the outlet 146. The stepped-speed minimizes the chances of material from plugging the accumulator 124. Further, the stepped-speed configuration allows material within the accumulator chamber 130 to be stirred to promote even flow from the inlet 144 to the outlet 146.

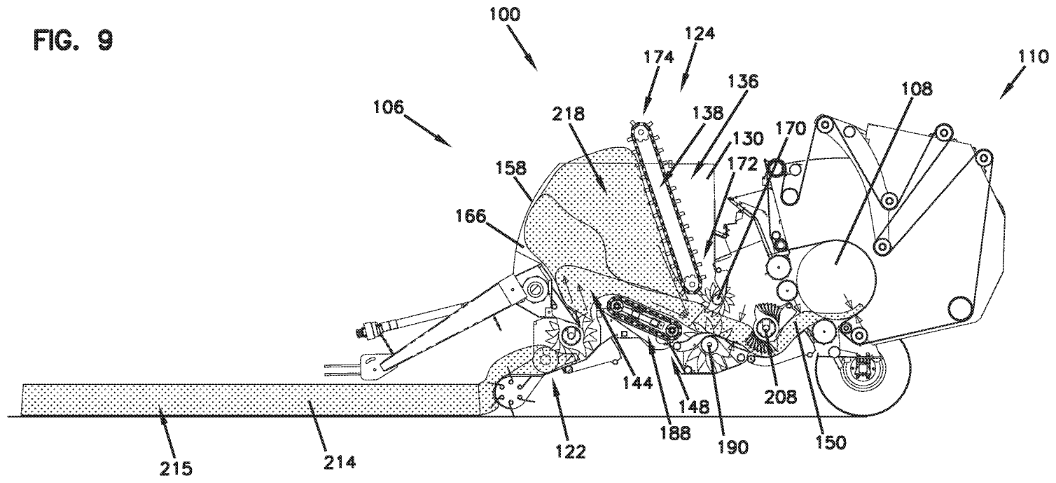

FIGS. 5-9 show the operation of the baling machine 100 during normal operation conditions. Specifically, FIG. 5 and FIG. 9 show the baling machine 100 in the baling cycle, and FIGS. 6-8 show the baling machine 100 during the non-baling cycle.

FIG. 5 shows an example of a first baling cycle of an operation. During the first baling cycle, the baling chamber 108 and the accumulator chamber 130 both start empty of material 216. As such, the upper conveyor rake 138 begins the baling cycle in the lowered position. In the depicted example, when in the lowered position, at least a portion of the upper conveyor rake 138 is positioned above the inlet 144 of the accumulator chamber 130. In the depicted example, when in the lowered position, the second end 174 of the upper conveyor rake 138 is generally positioned above the inlet 144 of the accumulator chamber 130. In some examples, the accumulator chamber 130 includes a stop 213 to prevent further downward movement of the upper conveyor rake 138.

As shown in FIG. 5, the baling machine 100 is aligned with a windrow 215 (i.e., a pile) of material 216. As the baling machine 100 encounters the windrow 215, the infeed assembly 122 begins to pick up the material 216 from the windrow 215, moving material 216 into the outlet 143 of the infeed assembly 122. The infeed rotor 142 moves material 216 in an upwardly direction through the inlet 144 of the accumulator chamber 130. Once through the inlet 144 of the accumulator chamber 130, the material 216 encounters the upper conveyor rake 138.

Because the baling machine 100 is operating during a baling cycle in FIG. 5, the upper conveyor body 178 is rotating about the upper conveyor frame 176 in a direction toward the outlet 146 of the accumulator chamber 130. Concurrently, the lower conveyor body 198 is also rotating about the lower conveyor frame 196 in a direction toward the outlet 146. In some examples, during the baling cycle, the lower conveyor body 198 is rotating about the lower conveyor frame 196 at a substantially lower speed than the upper conveyor body 178 is rotating about the upper conveyor frame 176.

As upwardly moving material 216 encounters the upper conveyor rake 138, the upper conveyor rake 138 moves the material 216 in a direction toward the outlet 146. At such a time, due in part to gravity, the material 216 moves in a tumbling, stirring manner toward the bottom side 135 of the accumulator chamber 130. Once at the bottom side 135, the material 216 encounters the lower conveyor rake 188, which also stirs the material 216 and moves the material 216 toward the outlet 146. The downward sloping lower conveyor rake 188 further promotes tumbling and spiraling of the material 216 as the material 216 is pushed to the outlet 146.

When material 216 reaches the outlet 146, both the upper and lower rotor rakes 170, 190 pass the material 216 into the inlet 150 of the baling chamber 108. The upper and lower rotor rakes 170, 190 continue to sift and stir material 216 using teeth 171, 200 as the material 216 moves past upper and lower rotor rakes 170, 190 and through the outlet 146 of the accumulator chamber 130. In some examples, the lower rotor rake 190 is moving faster than the upper rotor rake 170, thus promoting additional stirring.

When material 216 reaches the inlet 150 of the baling chamber 108, the baler inlet rotor 208 pulls the material 216 up and into the baling chamber 108.

FIG. 6 shows the baling machine 100 during the non-baling cycle. During the non-baling cycle, material 216 is not delivered to the baling chamber 108. Similar to FIG. 5, material 216 is shown to be picked up by the infeed assembly 122 and moved upwardly into the accumulator chamber 130 at the inlet 144 of the accumulator chamber 130. However, as depicted, rotation of both the upper and lower conveyor rakes 138, 188 is stopped. Because of this, material 216 does not progress to the baling chamber 108. In other examples, the upper rotor rake 170 also stops rotating during a non-baling cycle. In some examples, the lower rotor rake 190 continues to rotate during a non-baling cycle. In other examples, the lower rotor rake 190 stops rotating during a non-baling cycle. Because material 216 does not progress to the baling chamber 108, as material 216 is continuously fed upwardly into the inlet 144, material 216 begins to accumulate within the accumulator chamber 130 while simultaneously beginning to exert force upward on the upper conveyor rake 138 at the front side 166 of the accumulator chamber 130.

FIG. 7 again shows the baling machine 100 during the non-baling cycle. As material 216 begins to accumulate within the accumulator chamber 130, the material 216 begins to pile at the front side 166 of the accumulator chamber 130 within a storage volume 218. The storage volume 218 is an area within the accumulator chamber 130 where material 216 accumulates. In some examples, material 216 can accumulate below or above the upper conveyor rake 138. The accumulating of material at the front side 166 of the accumulator chamber 130 is due in part to both the location of the inlet 144 at the front side 166 and the movement within the range of motion M of the upper conveyor rake 138 within the accumulator chamber. In some examples, the infeed assembly 122 directs material 216 through the inlet 144, toward the front wall 158 of the accumulator chamber 130, thus leading to a tumbling material flow. In the depicted example, the upper conveyor rake 138 floats on top of the material 216 as the material 216 accumulates within the front side 166 of the accumulator chamber 130. In the depicted example, the upper conveyor rake 138 floats while not rotating. In some examples, the upper conveyor rake 138 floats while also concurrently rotating.

As material 216 continues to accumulate, the material 216 at least partially exerts an upward force on the upper conveyor rake 138, raising the upper conveyor rake 138 away from the inlet 144 within the accumulator chamber 130. This can be advantageous for both retaining the material 216 within the accumulator chamber 130 and for proper feeding of the material 216 toward the outlet 146. In some examples, the tumbling, swirling, and/or sifting motion of the material 216 as it travels from the inlet 144 to the outlet 146 results in the accumulator 124 delivering material 216 to the inlet 150 of the baling chamber 108 in a uniform way that promotes the forming of a uniformly shaped bale within the baling chamber 108. In some examples, the material 216 that is delivered to the baler inlet 150 mimics that of material picked up from an ideal windrow. In some examples, the tumbling, swirling, and/or sifting motion of the material 216 as it travels from the inlet 144 to the outlet 146 results in the accumulator 124 delivering material 216 to the inlet 150 of the baling chamber 108 in a way that promotes the forming of bales having densely formed sides.

As the upper conveyor rake 138 floats, the second end 174 has a greater range of motion than the first end 172. In the depicted examples, as the upper conveyor rake 138 floats, the second end 174 moves about the first end 172 in a pivoting motion. As shown, the upper conveyor rake 138 is in a raised position with respect to the lowered position shown in FIG. 5. In the raised positioned, the second end 174 is positioned further away from the inlet 144 than when in the lowered position. In the depicted example, as the upper conveyor rake 138 moves within the accumulator chamber 130, the upper conveyor rake 138 expands the storage volume 218 within the accumulator chamber 130 where material 216 accumulates between the bottom side 135 and the upper conveyor rake 138. In some examples, the storage volume 218 is expanded while the size of outlet 146 stays generally constant. In some examples, as storage volume 218 is expanded, the second end 174 of the upper conveyor rake 138 moves away from the lower rake assembly 148 while the first end 172 maintains a constant spacing from the lower rake assembly 148. In other examples, as storage volume 218 is expanded, the second end 174 of the upper conveyor rake 138 moves away at a faster rate from the lower rake assembly 148 and the bottom side 135 than the first end 172 moves away from the lower rake assembly 148 and the bottom side 135.

In other examples, the first end 172 can be permitted to move in addition to the second end 174. In such an example, the first end 172 moves less than the second end 174.

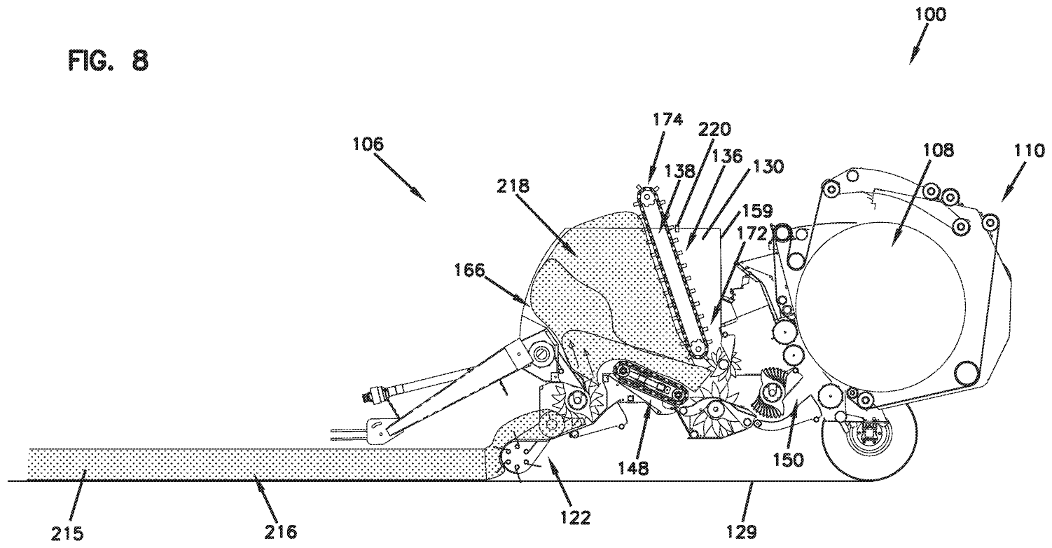

FIG. 8 shows the storage volume 218 further expanded by the upper conveyor rake 138 during a non-baling cycle. As shown, the upper conveyor rake 138 is in another raised position. In some examples, when in the raised position, the upper conveyor rake 138 can be generally parallel to a back wall 159. In some examples, when in the raised position, the upper conveyor rake 138 is in a generally vertical position with respect to the ground 129. In some examples, the baling machine 100 includes a raised position stop 220 that is movable to allow the user to customize the raised position of the upper conveyor rake 138. The raised position stop 220 can be configured to interact with upper conveyor rake 138 to prevent further movement of the second end 174 of the upper conveyor rake 138 away from the inlet 144. In some examples, the raised position stop 220 can engage the upper conveyor rake 138 to lock the upper conveyor rake 138 in the raised position. This can be advantageous when baling particular crop material.

FIG. 9 shows the baling machine 100 beginning a baling cycle with material 216 accumulated within the accumulator chamber 130. Accordingly, the respective conveyor bodies 178, 198 of upper and lower conveyor rakes 138, 188 are again operated to rotate in a direction toward the outlet 146 of the accumulator chamber 130. In the depicted example, the upper and lower rake assemblies 136, 148 function to at least partially grasp, tear, sift, and/or stir material 216 within the storage volume 218. Material 216 is pushed toward the outlet 146 from the storage volume 218, grasped, torn, sifted, and/or stirred at the outlet 146 by way of the upper and lower rotor rakes 170, 190 into the baling chamber inlet 150, and through the baling chamber inlet 150 and into the baling chamber 108 by the baler inlet rotor 208. In some examples, the upper and lower rotor rakes 170, 190 can aid in preventing plugs of material 216 from being delivered to the baler inlet 150 by tearing, sifting, and/or stirring the material 216 at the outlet 146. Further, such tearing, sifting, and/or stirring the material 216 at the outlet 146 can also ensure uniform delivery of the material 216 to the baler inlet rotor 208. Once within the baling chamber 108, the material 216 is compressed to form a bale.

As material 216 flows toward the outlet 146, the amount of material 216 within the accumulator chamber 130 is reduced. Because the baling machine 100 is configured to be operated in a continuously moving fashion, material 216 is both exiting the accumulator chamber 130 via the outlet 146 and entering the accumulator chamber via the inlet 144. As shown, the material 216 generally flows first upward, then downward and over toward the outlet 146 within the accumulator chamber 130. In the depicted example, the baling machine 100 is configured so that material 216 leaves the accumulator chamber 130 at a faster rate than material 216 enters the accumulator chamber 130. Because of this, during the baling cycle, the upper conveyor rake 138, specifically the second end 174, moves back in a direction toward the inlet 144 as the amount of material 216 within the storage volume 218, and therefore the amount of upward force on the upper conveyor rake 138, is reduced. The floating of the upper conveyor rake 138 allows for consistent movement of the material 216 within the storage volume 218 during the baling cycle by the upper conveyor rake 138, thus providing a consistent, uniform flow of material 216 to the outlet 146.

This material movement process is carried out through the baling cycle until the baling chamber 108 is filled with enough material 216 to form a complete bale. At such a time, the baling machine 100 again enters into the non-baling cycle, substantially similar to that shown in FIGS. 6-8, and the process repeats.

FIG. 10 shows a biasing member 139 attached to the upper conveyor rake 138 and a portion (such as the housing 132 of the accumulator chamber 130) of the baling machine 100. In some examples, the biasing member 139 biases the upper conveyor rake 138 toward the inlet 144, bottom side 135, and lower rake assembly 148. In some examples, the biasing member 139 can be used to increase the amount of upward material force that is required to move the upper conveyor rake 138 when material accumulates within the accumulator chamber 130. In some examples, the biasing member 139 allows the upper conveyor rake 138 to float on top of material as material enters the accumulator chamber 130 at the inlet 144. In some examples, the biasing member 139 is a spring, actuator, and/or other like device.

FIG. 11 shows an actuator 141 attached to the upper conveyor rake 138 and a portion of the baling machine 100, such as the housing 132. The actuator 141 is configured to control the position of the upper conveyor rake 138 between the lowered and raised positions. In some examples, the actuator 141 is a hydraulic actuator in communication with the hydraulic power input 120. In some examples, the actuator 141 can be disengaged to allow the upper conveyor rake 138 to freely move and float within the accumulator chamber 130. In some examples, the actuator 141 can be utilized the limit the overall range of motion M of the upper conveyor rake 138.

In some examples, the actuator 141 can be utilized to power the movement of the upper conveyor rake 138. For example, if an unwanted plugging of material is occurring within the accumulator chamber 130, the actuator 141 can lift the upper conveyor rake 138 toward the raised position to aid in clearing the plug.

In some examples, the actuator 141 can control the amount of upward material force that is required to move the upper conveyor rake 138 when material accumulates within the accumulator chamber 130. For example, the actuator 141 can increase the amount of upward material force that is required to move the upper conveyor rake 138 by operating as a damper to alter the floating movement of the upper conveyor rake 138.

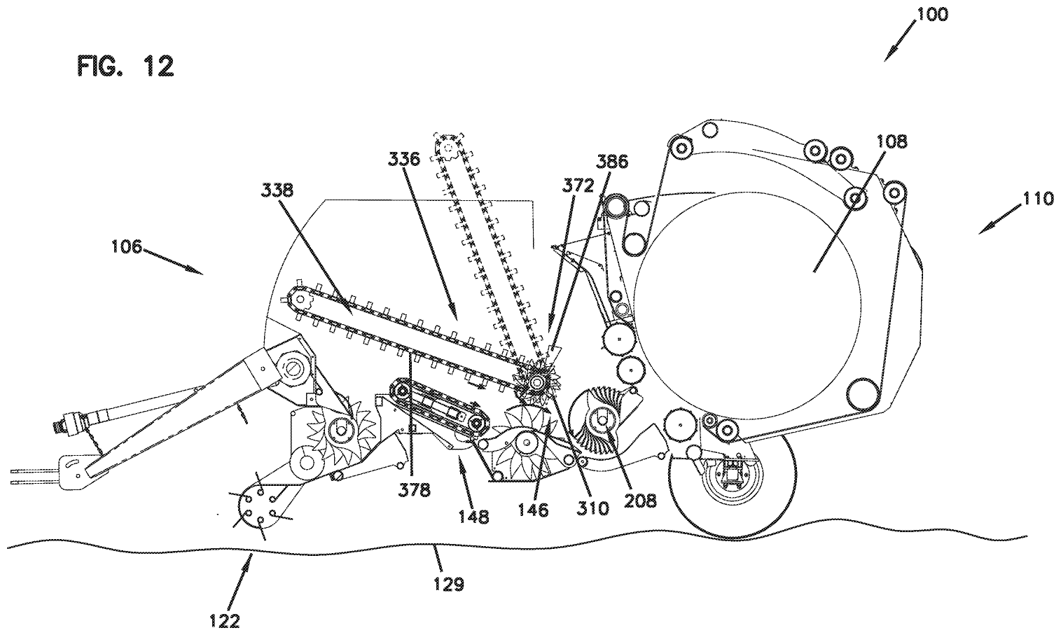

FIG. 12 show an alternative example of an upper rake assembly 336. As shown, similar to the upper rake assembly 136, the upper rake assembly 336 is movable between a lowered position and a raised position (shown in phantom lines). The upper rake assembly 336 includes an upper conveyor rake 338 and an upper rotor rake 370. The upper conveyor rake 338 and upper rotor rake 370 are substantially similar to the upper conveyor rake 138 and the upper rotor rake 170, described above. However, as shown in FIG. 12, the upper rotor rake 370 is positioned within the upper conveyor rake 338 at a first end 372 of the upper conveyor rake 338. In some examples, the upper rotor rake 370 and upper conveyor rake 338 share a common shaft 373 at the first end 372 of upper conveyor rake 338. In some examples, the upper rotor rake 370 can be rotated with an upper conveyor body 378 (substantially similar to the upper conveyor body 178). In some examples, the upper rotor rake 370 can be rotated separately and/or at a different speed than the upper conveyor body 378. In some examples, an upper rotor rake material stripper 386 is positioned adjacent the upper rotor rake 370 to strip material from the upper rotor rake 370 and/or from the first end 372 of the upper conveyor rake 338. The upper rotor rake material stripper 386 can be substantially similar to the upper rotor rake material stripper device 186, as described above.

FIGS. 13-15 show examples of drop pan arrangements that the baling machine 100 can be equipped with. Drop pans, as noted above, allow the operator to, either remotely or manually, remove a portion of shielding or housing to quickly access portions of the baling machine 100.

As shown in FIG. 13, the infeed drop pan 162 that is positioned under the infeed rotor 142 and the drop pan 210 that is positioned under the baler inlet rotor 208 are movable away from the infeed rotor 142 and baler inlet rotor 208, respectively. In some examples, the drop pans 162, 210 are movable to clear debris trapped between the drop pans 162, 210 and their respective rotors 142, 208.

As depicted, the drop pan 210 is positioned under the baler inlet rotor 208 and is configured to be pivoted at a leading edge 211 about pivot point 213. In the depicted examples, the leading edge 211 and pivot point 213 are positioned directly adjacent a trailing edge 205 of the lower rotor rake material stripper device 204. In some examples, the leading edge 211 of the drop pan 210 is positioned at a distance D1 from the axis E of the baler inlet rotor 208, and the trailing edge 205 of the lower rotor rake material stripper device 204 is positioned at a distance D2 from the axis E of the baler inlet rotor 208. In some examples, D1 is greater than D2. In other examples, D1 is greater than, or equal to, D2. In other examples still, D1 is equal to, or less than, D2.

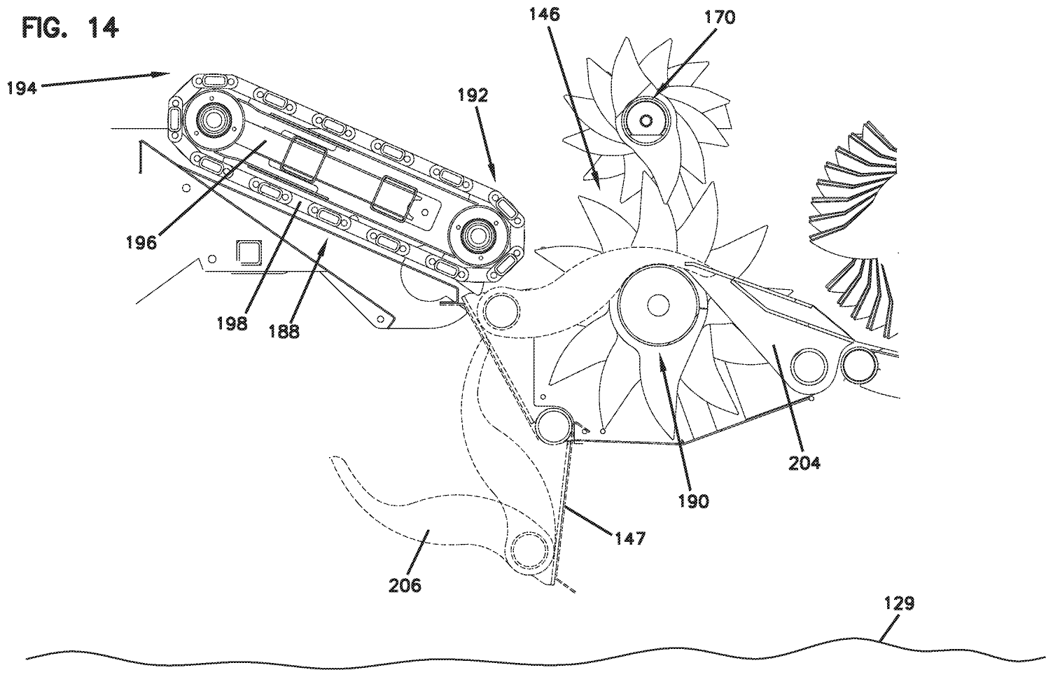

FIG. 14 shows a lower rake assembly drop pan 147 positioned below and between the lower conveyor rake 188 and the lower rotor rake 190. In some examples, the lower rake assembly drop pan 147 can be attached to the lower conveyor material stripper device 206. The lower rake assembly drop pan 147 is selectively movable toward the ground surface 129 to gain access to portions of the lower rake assembly 148 and/or to clear debris trapped between the drop pan 147 and the lower rake assembly 148.

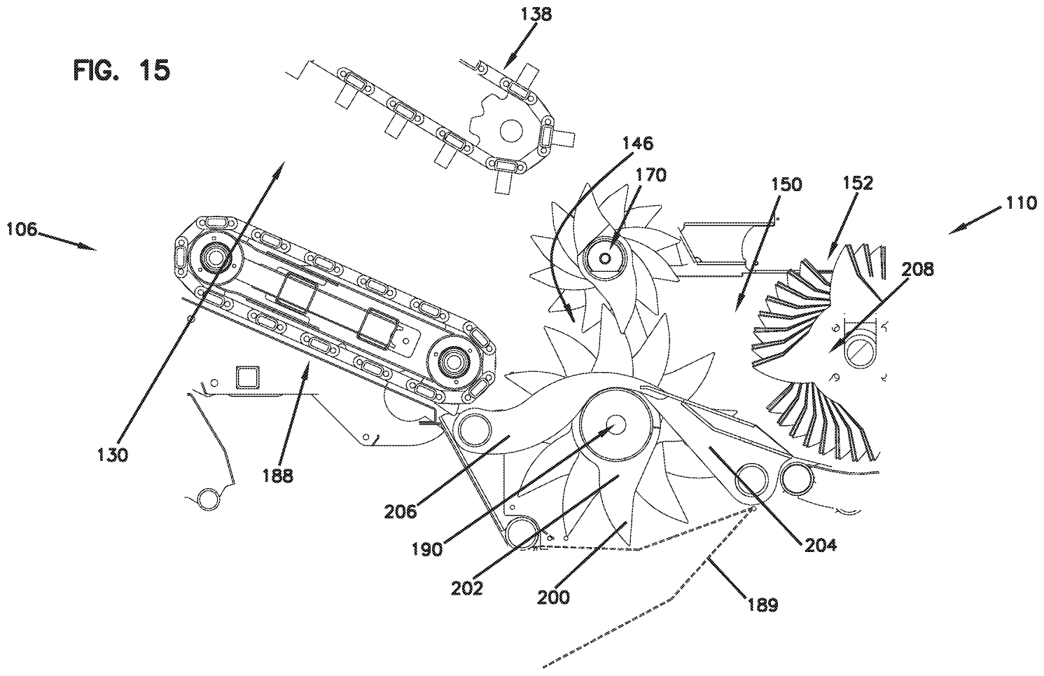

FIG. 15 shows a lower rotor rake drop pan 189 positioned below the lower rotor rake 190. In some examples, the lower rotor rake drop pan 189 is selectively movable toward the ground surface 129 to gain access to portions of the lower rotor rake 190 and/or to clear debris trapped between the drop pan 189 and the lower rotor rake 190.

In some examples, the drop pans 162, 210, 147, 189 are hingedly attached to the baling machine 100 to facilitate easier removal and lowering. In some examples, the movement of drop pans 62, 210, 147, 189 is powered (i.e., by way of an actuator or other like device) so that the drop pans 62, 210, 147, 189 can be remotely lowered and raised by the operator during operation to facilitate the quick clearing of unwanted trapped or plugged material within the accumulator 124.

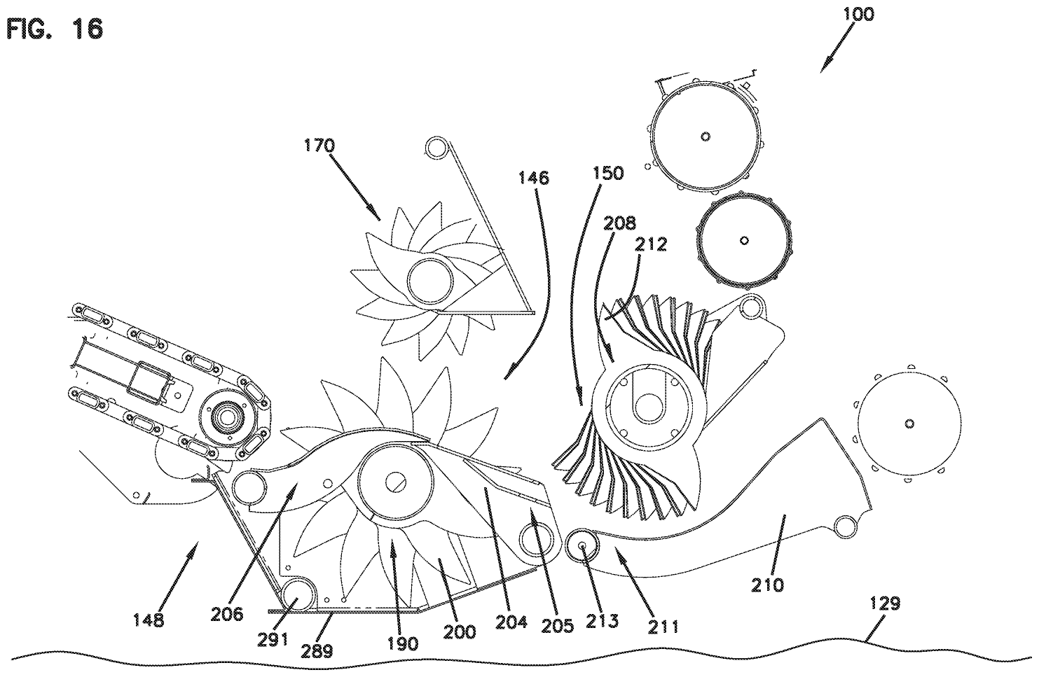

FIGS. 16-18 show another example of a drop pan arrangement. In the depicted example, the baling machine 100 includes a lower rotor rake drop pan 289 positioned below the lower rotor rake 190. In some examples, the lower rotor rake drop pan 289, like drop pan 189 described above, is selectively movable toward the ground surface 129 to gain access to portions of the lower rotor rake 190 and/or to clear debris trapped within the accumulator chamber 130. The drop pan 289 is configured to be pivotable about pivot point 291.

In the depicted example, the lower rotor rake material stripper device 204 is connected to the drop pan 289 to be movable with the drop pan 289 (i.e., the stripper device 204 lowers as the drop pan 289 lowers).

In some examples, the drop pan 289 can be operated together with, and/or separately from, the baler inlet drop pan 210 to clear a plug of material within the accumulator chamber 130, specifically near the outlet 146, and/or the inlet 150 of the baling chamber 108.

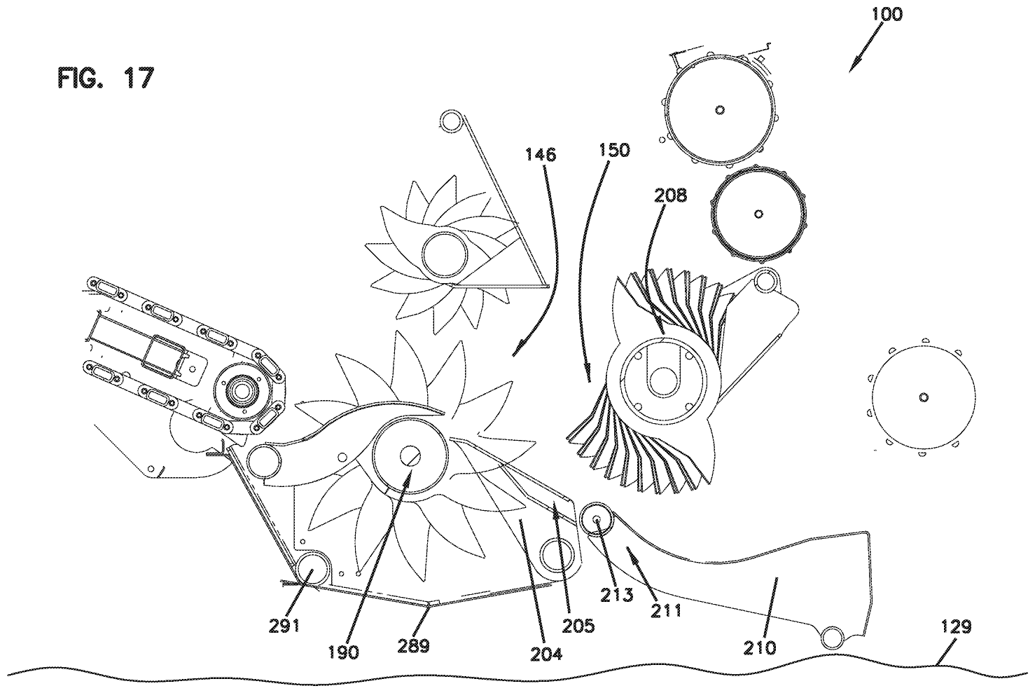

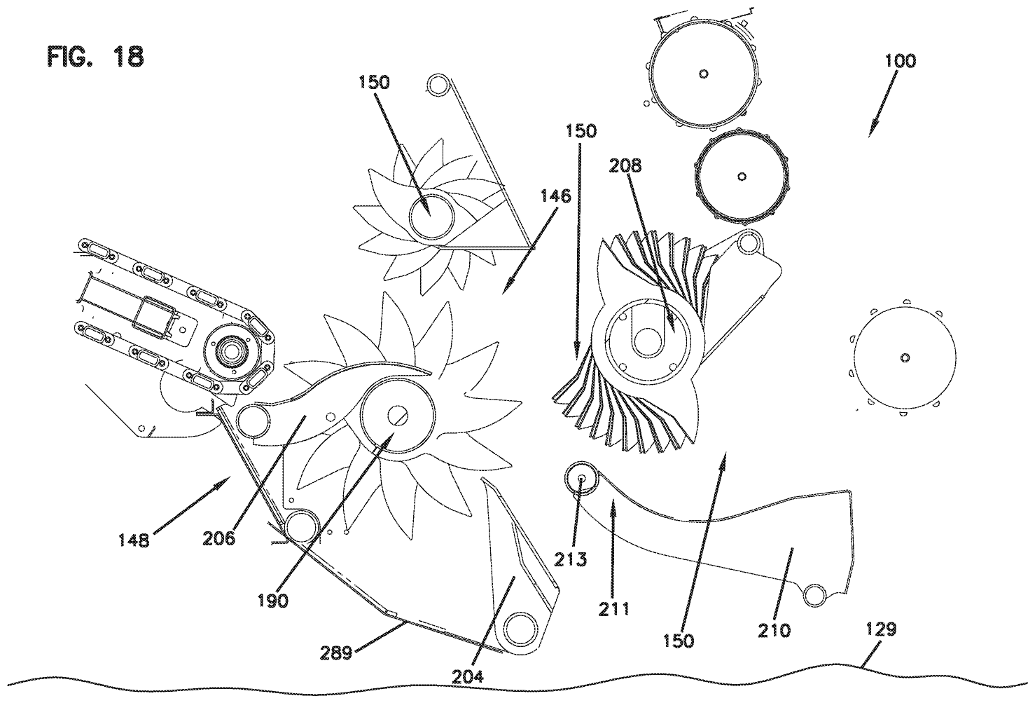

FIGS. 17-18 show the method of lowering both the drop 289 and the drop pan 210 in a direction toward the ground surface 129. Such lowering increases the size of both the outlet 146 of the accumulator chamber 130 and the inlet 150 of the baling chamber 108. Further, in some examples, the lowering of the drop pans 289, 210 allows for material positioned within the accumulator chamber 130, near the drop pans 289, 210, to drop from the accumulator chamber 130 toward the ground 129. In some examples, this can be done remotely by the operator. In some examples, the lowering of the drop pans 289, 210 can be done in response to an unwanted plugging and/or at a specific time during the baling cycle. For example, the baling machine 100 can be configured to sense when an unwanted plug exists using sensors and/or devices that are in communication with the lower rotor rake 190 and/or the baler inlet rotor 208. In some examples, in response to an unwanted plug existing, the baling machine can automatically alter the behavior of the lower rotor rake 190 and/or the baler inlet rotor 208.

In the depicted example shown in FIG. 18, once lowered, the stripper device 204 attached to drop pan 289 is at least partially positioned below the pivot point 213 of the drop pan 210.

In some examples, to clear an unwanted plug adjacent the outlet 146 of the accumulator chamber 130 and/or adjacent the inlet 150 of the baling chamber 108, the operator can first cease rotation of the baler inlet rotor 208. Once rotation is stopped, the operator lowers the drop pan 210. Once lowered, the operator resumes rotation of at least the baler inlet rotor 208, and in some examples, also the lower rotor rake 190. The increased space of the inlet 150 created by lowering the drop pan 210 can aid in propelling the plugged material past the inlet 150 and into the baling chamber 130.

In some examples, to clear an unwanted plug adjacent the outlet 146 of the accumulator chamber 130 and/or adjacent the inlet 150 of the baling chamber 108, the operator can first cease rotation of the baler inlet rotor 208 and the lower rotor rake 190. Once rotation is stopped, the operator lowers the drop pans 210, 289. Once lowered, the operator resumes rotation of the baler inlet rotor 208 and the lower rotor rake 190 to aid in propelling the plugged material past the inlet 150 and into the baling chamber 130. In some examples, first, the operator can lower only the drop pan 210 and resume rotation of the baler inlet root 208 to attempt to clear the plug material. Should the plugged material remain, the operator can continue and lower the drop pan 289 and resume rotation of the lower rotor rake 190 in attempt to the clear the plugged material.

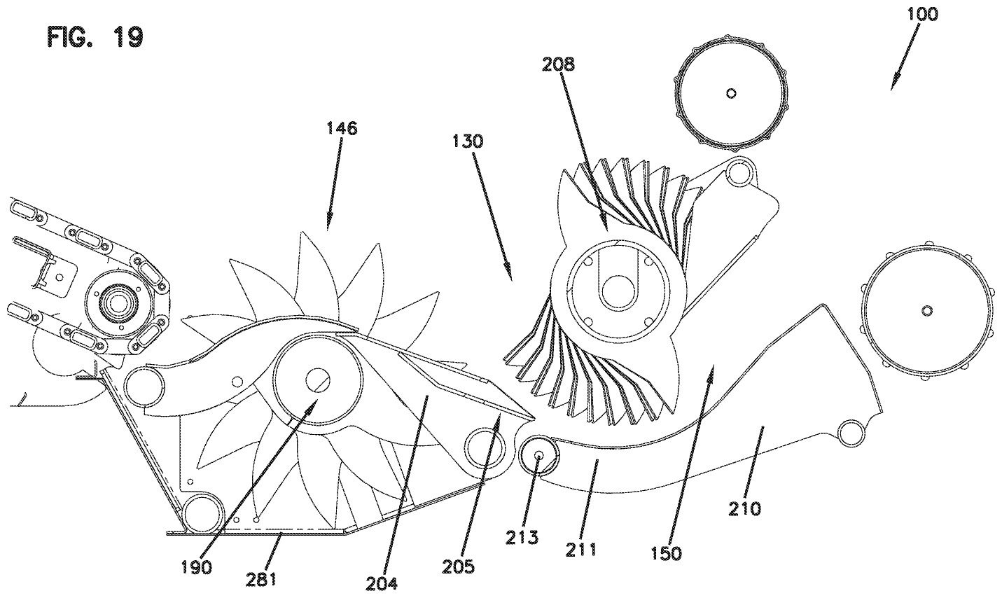

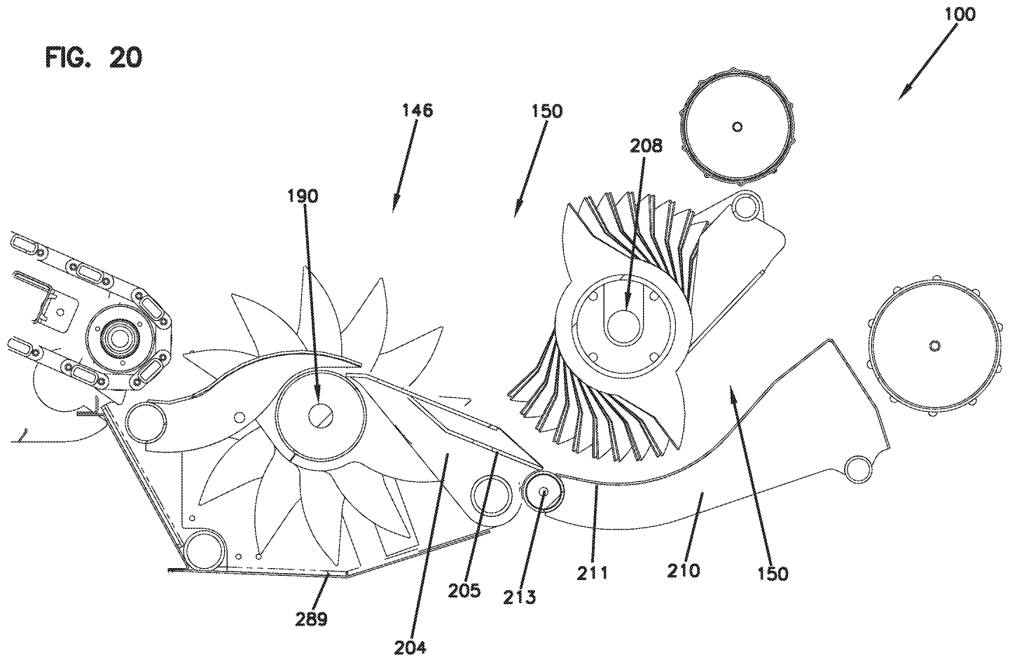

FIGS. 19-20 depict another method of clearing an unwanted plug. In some examples, to clear an unwanted material plug, the operator can slightly lower the stripper device 204 to position the stripper device 204 a distance that is closer to the trailing edge 213 of the drop pan 210, as shown in FIG. 20.

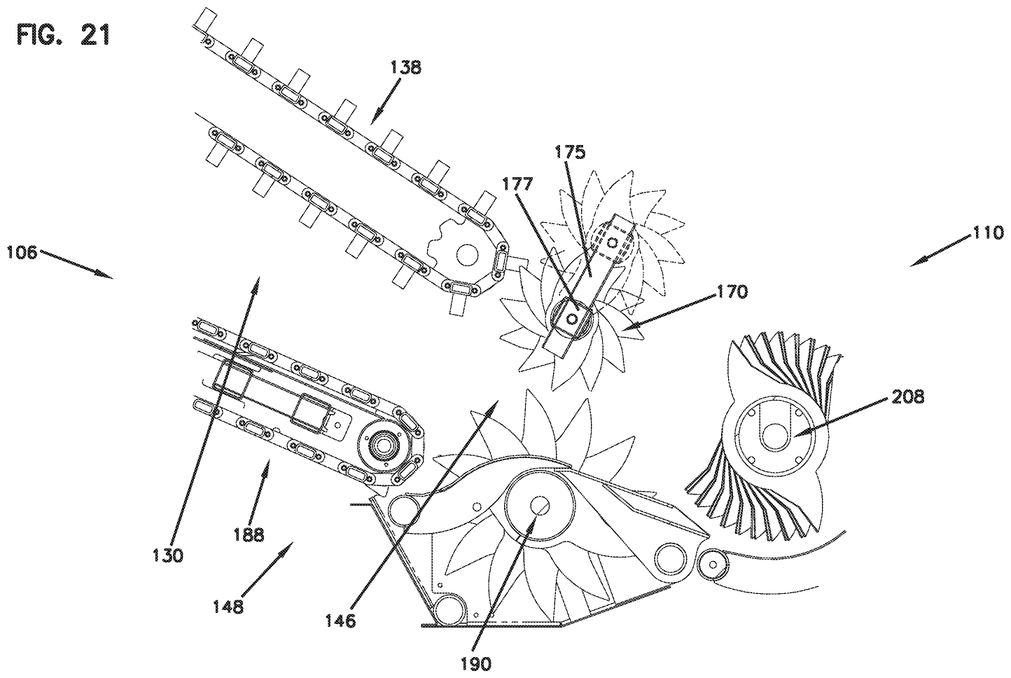

FIG. 21 shows a portion of the baling machine 100 with the upper rotor rake 170 being movable. In the depicted example, the upper rotor rake 170 is mounted to be selectively movable away (as shown by upper rotor rake 170 in phantom lines) or toward the outlet 146 of the accumulator chamber 130. In some examples, the operator may desire to move the upper rotor rake 170 away from the outlet 146 to clear unwanted plugged material within the outlet 146. Further, the position of the upper rotor rake 170 with respect to the outlet 146 can be dependent on the material the baling machine 100 is baling. For example, with larger material that tends to clump together, the operator may desire to increase the size of the outlet 146 by moving the upper rotor rake 170 away from the outlet 146. In some examples, the movement of the upper rotor rake 170 can be a powered movement controlled remotely by the operator and/or automatically with the control system 182. In other examples, the movement of the upper rotor rake 170 can be manually actuated. In other examples, the upper rotor rake 170 can be spring biased toward the outlet 146 so that if an unwanted plug is present at the outlet 146, the spring force would be overcome, and the material could force the upper rotor rake 170 away from the outlet 146. In some examples, the upper rotor rake 170 is slidably mounted on a member 175 via a bracket 177.

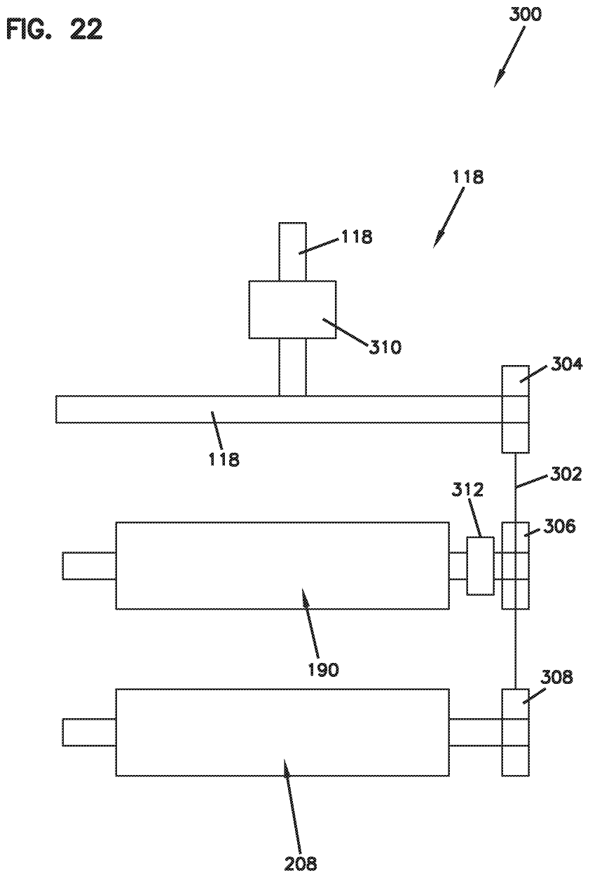

FIG. 22 shows a schematic example driveline arrangement 300 for the baling machine 100. The driveline arrangement 300 depicts the mechanical power input 118 being configured to power the rotation of the lower rotor rake 190 and the baler inlet rotor 208. In some examples, the mechanical power input 118 transfers power to the lower rotor rake 190 and the baler inlet rotor 208 via a chain 302, or other like device. The chain 302 can be rotated via mechanical power input 118 at an input sprocket 304, which then transfers rotation to the lower rotor rake 190 and the baler inlet rotor 208 via a lower rotor rake sprocket 306 and a baler inlet rotor sprocket 308, respectively.

In the depicted example, the driveline arrangement 300 also includes a pair of torque-limiting devices 310, 312. In some examples, the torque-limiting devices 310, 312 can protect the components of the baling machine 100 should the rotation of the components become restricted by, for example, plugged material. In some examples, at least one of the torque limiting devices 310, 312 is a clutch. In some examples, at least one of the torque limiting devices 310, 312 is a slip clutch. In some examples, at least one of the torque limiting devices 310, 312 is a radial pin clutch. An example of a radial pin clutch is disclosed in U.S. Pat. No. 4,468,206, which is hereby incorporated by reference in its entirety.

An input torque-limiting device 310 is configured to control the maximum torque the mechanical power input 118 can transfer to the lower rotor rake 190 and the baler inlet rotor 208. In some examples, once a threshold torque value is exceeded, the input torque-limiting device 310 can decouple the lower rotor rake 190 and the baler inlet rotor 208 from the mechanical power input 118 to prevent damage.

A lower rotor rake torque-limiting device 312 is configured to separately limit the torque of the lower rotor rake 190 from the overall torque of the arrangement 300, which is controlled by the input torque-limiting device 310. In some examples, the lower rake rotor torque-limiting device 312 can be in communication with the lower rotor rake 190. In some examples, the lower rotor rake torque-limiting device 312 can be in communication with the lower rotor rake 190 when the lower rotor rake 190 does not have a drop pan installed below it. This can aid in reducing unwanted material plugs.

In some examples, when an unwanted material plug is present adjacent the lower rotor rake 190 and a threshold torque value is exceeded (e.g., lower than the threshold torque value of the input torque-limiting device 310), the lower rake rotor torque-limiting device 312 can control the operation of the lower rotor rake 190 so that the lower rotor rake 190 operates within a range of fluctuating torque values. Such torque fluctuation can be accomplished using a radial pin clutch. Further, such torque fluctuation can aid in processing an unwanted material plug.

In another example, the input torque-limiting device 310 is a cut-out clutch, as is described in U.S. Pat. No. 3,203,523, which is hereby incorporated by reference in its entirety, that is set to disengage completely once a maximum torque is reached, and the lower rake rotor torque-limiting device 312 is a radial pin clutch. In this example, the torque setting of the lower rake rotor torque-limiting device 312 is set at a torque level where the lower rake rotor torque-limiting device 312 will slip before the cut-out clutch disengages, with the intention that if a significant plug occurs, the slipping prevents both the lower rotor rake 190 and the baler inlet rotor 208 from rotating, then the input torque-limiting device 310 will disengage. This example would allow the operator to stop the drive system, so that the mechanical power input 118 would come to an approximate stop. Once this occurs, the input torque-limiting device 310, when configured as a cut-out clutch, will automatically re-engage, the operator can then open the drop-pans (e.g. drop pans 210, 289), and then re-engage drive to the mechanical power input 118 whereby the baler inlet rotor 208 should turn if the plugged material is released by opening of the drop pan 210, and the lower rotor rake 190 may not turn freely if there is a plug in front of the lower rotor rake 190. If that is the case, then the radial pin slip clutch will slip while generating a fluctuating torque on the lower rotor rake 190, to assist in driving that plug in a direction toward the baler inlet rotor 208.

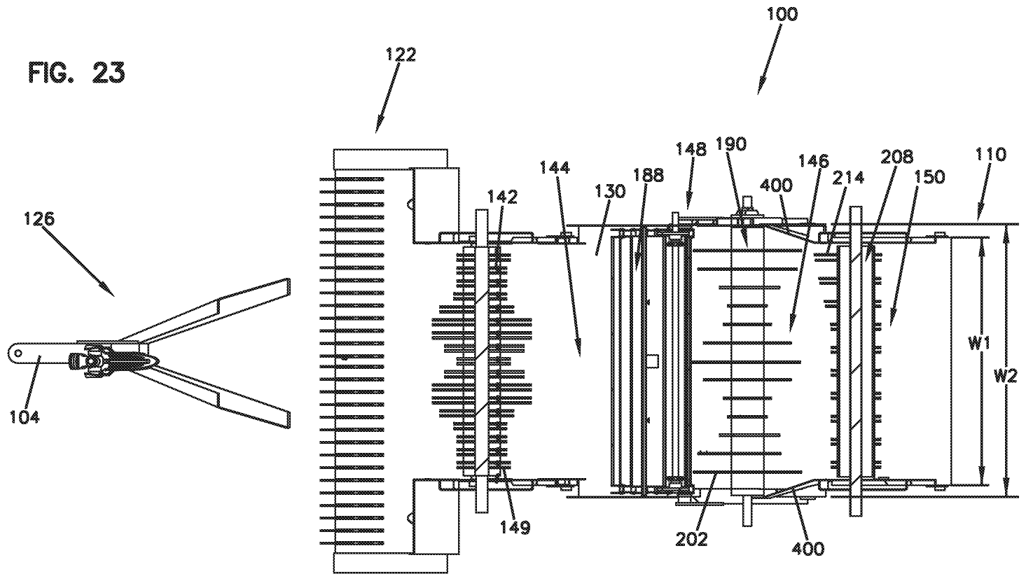

FIG. 23 shows a schematic top view of the baling machine 100. In the depicted example, the accumulator chamber 130 includes a pair of angled deflectors 400 that reduce the width W2 of the accumulator chamber 130 down to the width W1 of the baling chamber 108. In the depicted example, the deflectors 400 are positioned at the outlet 146 of the accumulator chamber 130, adjacent the inlet 150 of the baling chamber 108. In some examples, the deflectors 400 aid in increasing the density of material at the edges of the baler inlet 150 as it enters from the accumulator chamber 130. Such increased density can result in round bales produced by the baling chamber 108 that possess densely packed end portions, thereby increasing the handleability and structural integrity round bale.

### EXAMPLES

Illustrative examples of the baling machine disclosed herein are provided below. An example of the baling machine may include any one or more, and any combination of, the examples described below.

Example 1. A baling machine includes an accumulator chamber at least partially defined by a housing. The accumulator chamber includes an inlet, an outlet, and an internal volume. The baling machine includes an infeed assembly that is configured to deliver material to the inlet of the accumulator chamber. The baling machine includes a lower rake assembly that is positioned within the accumulator chamber. The lower rake assembly is operable to move material toward the outlet of the accumulator chamber. The baling machine includes an upper conveyor rake that is at least partially positioned and movable within the internal volume of the accumulator chamber. The upper conveyor rake has a first end, a second end, and a range of motion between a raised position and a lowered position. The second end of the upper conveyor rake has a greater range of motion than the first end. Through the majority of the range of motion of the upper conveyor rake between the raised position and the lowered position, the first end is positioned closer to the lower rake assembly than the second end.

Example 2. In combination with, or independent thereof, any example disclosed herein, the infeed assembly includes an infeed outlet generally aligned within the inlet of the accumulator chamber. The infeed outlet is positioned below the inlet of the accumulator chamber.

Example 3. In combination with, or independent thereof, any example disclosed herein, the lower rake assembly is positioned at a bottom side of the accumulator chamber.

Example 4. In combination with, or independent thereof, any example disclosed herein, the baling machine includes at least one drop pan positioned under at least a portion of the lower rake assembly. The at least one drop pan is movable to expose the at least a portion of the lower rake assembly at a bottom side of the accumulator chamber.

Example 5. In combination with, or independent thereof, any example disclosed herein, the lower rake assembly includes a lower conveyor rake and a lower rotor rake. The lower conveyor rake is positioned directly adjacent the inlet of the accumulator chamber and the lower rotor rake is positioned directly adjacent the outlet of the accumulator chamber.

Example 6. In combination with, or independent thereof, any example disclosed herein, the lower rotor rake is a rotor that includes a plurality of teeth.

Example 7. In combination with, or independent thereof, any example disclosed herein, the plurality of teeth of the lower rotor rake are arranged in a spiraling pattern along the lower rotor rake.

Example 8. In combination with, or independent thereof, any example disclosed herein, the baling machine includes an upper rotor rake positioned adjacent the first end of the upper conveyor rake and adjacent the outlet of the accumulator chamber.

Example 9. In combination with, or independent thereof, any example disclosed herein, the upper rotor rake is a rotor that includes a plurality of teeth. The plurality of teeth of the upper rotor rake are arranged in a spiraling pattern along the upper rotor rake.

Example 10. In combination with, or independent thereof, any example disclosed herein, the upper rotor rake at least partially defines a boundary of the outlet of the accumulator chamber.

Example 11. In combination with, or independent thereof, any example disclosed herein, the upper conveyor rake includes a frame and a rotatable conveyor body positioned around the frame. The rotatable conveyor body is operable in at least one of a direction toward the outlet of the accumulator chamber and a direction toward the inlet of the accumulator chamber.

Example 12. In combination with, or independent thereof, any example disclosed herein, the upper conveyor rake floats on material deposited within the accumulator chamber via the inlet.

Example 13. In combination with, or independent thereof, any example disclosed herein, material deposited within the accumulator chamber via the inlet exerts an upward force on the upper conveyor rake.

Example 14. In combination with, or independent thereof, any example disclosed herein, when in the lowered position, at least a portion of the upper conveyor rake is generally vertically positioned over at least a portion of the inlet of the accumulator chamber.

Example 15. In combination with, or independent thereof, any example disclosed herein, the upper conveyor rake is biased toward the lowered position.

Example 16. In combination with, or independent thereof, any example disclosed herein, the upper conveyor rake is biased toward the lowered position via a biasing member.

Example 17. In combination with, or independent thereof, any example disclosed herein, the biasing member is a spring.

Example 18. In combination with, or independent thereof, any example disclosed herein, the biasing member is a hydraulic cylinder.

Example 19. In combination with, or independent thereof, any example disclosed herein, the upper conveyor rake is powered at the first end by an upper conveyor driving input. The upper conveyor driving input is configured to rotate the rotatable conveyor body around the frame of the upper conveyor rake.

Example 20. In combination with, or independent thereof, any example disclosed herein, the upper conveyor driving input is in communication with a hydraulic motor.

Example 21. In combination with, or independent thereof, any example disclosed herein, the baling machine includes a sensor operable to sense at least one of a position, a speed, and a load of the upper conveyor rake.

Example 22. In combination with, or independent thereof, any example disclosed herein, the baling machine includes a controller in communication with the sensor. The controller alters the behavior of the upper conveyor rake based on a signal received from the sensor.

Example 23. In combination with, or independent thereof, any example disclosed herein, the baling machine includes a baling chamber inlet positioned adjacent the outlet of the accumulator chamber. The baling chamber inlet is operable to transfer material from the accumulator chamber to a baling chamber for creation of a round bale.

Example 24. In combination with, or independent thereof, any example disclosed herein, the baling machine includes an accumulator chamber at least partially defined by a housing. The accumulator chamber has an internal volume, a top side, and an opposite bottom side. The accumulator chamber includes an inlet positioned at a front of the bottom side and an outlet positioned at a rear of the bottom side. The baling machine includes an infeed assembly that includes an infeed outlet that is generally aligned and positioned below the inlet of the accumulator chamber to deposit material within the accumulator chamber through the inlet. The baling machine includes a lower rake assembly positioned at the bottom side of the accumulator chamber. The lower rake assembly is operable in a way to move material toward the outlet of the accumulator chamber. The baling machine includes an upper rake assembly that is at least partially positioned within the accumulator chamber and positioned vertically above the lower rake assembly. The upper rake assembly includes an upper conveyor rake. The upper conveyor rake includes a frame that has a first end and a second end. The upper conveyor rake is attached to the housing of the accumulator chamber at the first end of the frame. The upper conveyor rake includes a rotatable conveyor body positioned around the frame. The rotatable conveyor body is operable in at least one of a direction toward the outlet of the accumulator chamber and a direction toward the inlet of the accumulator chamber. The upper conveyor rake is movable about the first end between a raised position and a lowered position. When in the lowered position, at least a portion of the upper conveyor rake is generally vertically positioned over at least a portion of the inlet of the accumulator chamber.

Example 25. In combination with, or independent thereof, any example disclosed herein, the baling machine includes a drop pan positioned under at least a portion of the lower rake assembly. The drop pan is movable to expose the at least a portion of the lower rake assembly at the bottom side of the accumulator chamber.

Example 26. In combination with, or independent thereof, any example disclosed herein, the lower rake assembly includes a lower conveyor rake and a lower rotor rake. The lower conveyor rake is positioned directly adjacent the inlet of the accumulator chamber and the lower rotor rake is positioned directly adjacent the outlet of the accumulator chamber.

Example 27. In combination with, or independent thereof, any example disclosed herein, the lower rotor rake is a rotor that includes a plurality of teeth.

Example 28. In combination with, or independent thereof, any example disclosed herein, the plurality of teeth of the lower rotor rake are arranged in a spiraling pattern along the lower rotor rake.

Example 29. In combination with, or independent thereof, any example disclosed herein, the upper rake assembly further comprises an upper rotor rake positioned adjacent the first end of the upper conveyor rake and adjacent the outlet of the accumulator chamber.

Example 30. In combination with, or independent thereof, any example disclosed herein, the upper rotor rake is a rotor that includes a plurality of teeth. The plurality of teeth of the upper rotor rake are arranged in a spiraling pattern along the upper rotor rake.

Example 31. In combination with, or independent thereof, any example disclosed herein, the upper rotor rake at least partially defines a boundary of the outlet of the accumulator chamber.

Example 32. In combination with, or independent thereof, any example disclosed herein, during operation of the baling machine, the upper rotor rake rotates at a speed that is greater than the rotation of at least a portion of the lower rake assembly and greater than the rotation of the upper conveyor rake.

Example 33. In combination with, or independent thereof, any example disclosed herein, the upper conveyor rake floats on material deposited within the accumulator chamber via the inlet.

Example 34. In combination with, or independent thereof, any example disclosed herein, material deposited within the accumulator chamber via the inlet exerts an upward force on the upper conveyor rake.

Example 35. In combination with, or independent thereof, any example disclosed herein, the upper conveyor rake is biased toward the lowered position.

Example 36. In combination with, or independent thereof, any example disclosed herein, the upper conveyor rake is biased toward the lowered position via a biasing member.

Example 37. In combination with, or independent thereof, any example disclosed herein, the biasing member is a spring.

Example 38. In combination with, or independent thereof, any example disclosed herein, the biasing member is a hydraulic cylinder.

Example 39. In combination with, or independent thereof, any example disclosed herein, the upper conveyor rake is powered at the first end by an upper conveyor driving input. The upper conveyor driving input is configured to rotate the rotatable conveyor body around the frame of the upper conveyor rake.

Example 40. In combination with, or independent thereof, any example disclosed herein, the upper conveyor driving input is in communication with a hydraulic motor.

Example 41. In combination with, or independent thereof, any example disclosed herein, the baling machine includes a sensor operable to sense at least one of a position, a speed, and a load of the upper conveyor rake.

Example 42. In combination with, or independent thereof, any example disclosed herein, the baling machine includes a controller in communication with the sensor, wherein the controller alters the behavior of the upper conveyor rake based on a signal received from the sensor.

Example 43. In combination with, or independent thereof, any example disclosed herein, a method of operating a baling machine includes providing an accumulator chamber at least partially defined by a housing. The accumulator chamber has an internal volume, a top side, and an opposite bottom side. The accumulator chamber includes an inlet positioned at a front of the bottom side and an outlet positioned at a rear of the bottom side. The method includes delivering material in an upward direction to the inlet of the accumulator chamber. The method includes moving at least a portion of an upper rake assembly within the internal volume of the accumulator chamber from the bottom side of the accumulator chamber toward the top side of the accumulator chamber upon receipt of material into the accumulator chamber via the inlet. The method includes moving material from the inlet to the outlet of the accumulator chamber. The method includes delivering material from the outlet of the accumulator chamber to an inlet of a round baling chamber. The method includes forming a round bale within the baling chamber with material moved from the accumulator chamber.

Example 44. In combination with, or independent thereof, any example disclosed herein, the method of operating a baling machine includes exerting an upward force on the upper rake assembly by material received at the inlet of the accumulator chamber.

Example 45. In combination with, or independent thereof, any example disclosed herein, the method of operating a baling machine includes operating the upper rake assembly to move material from the inlet to the outlet of the accumulator chamber.

Example 46. In combination with, or independent thereof, any example disclosed herein, the method of operating a baling machine includes operating a lower rake assembly positioned adjacent the bottom side of the accumulator chamber, below the upper rake assembly, to move material from the inlet to the outlet of the accumulator chamber.

Example 47. In combination with, or independent thereof, any example disclosed herein, the method of operating a baling machine includes moving material at least partially in a downward direction from the inlet to the outlet of the accumulator chamber.

Example 48. In combination with, or independent thereof, any example disclosed herein, the method of operating a baling machine includes sensing at least one of a position, a speed, and a load of the of the upper rake assembly with a sensor.

Example 49. In combination with, or independent thereof, any example disclosed herein, the method of operating a baling machine includes automatically altering the behavior of the upper rake assembly based on a signal received from the sensor.

Example 50. In combination with, or independent thereof, any example disclosed herein, the upper rake assembly includes an upper conveyor rake having a first end, a second end, and a range of motion between a raised position and a lowered position, the second end having a greater range of motion than the first end, and wherein, through the majority of the range of motion between the raised position and the lowered position, the first end is positioned closer to the bottom side of the accumulator chamber than the second end.

Example 51. In combination with, or independent thereof, any example disclosed herein, the baling machine includes an accumulator chamber at least partially defined by a housing. The accumulator chamber has an internal volume, a top side, and an opposite bottom side. The accumulator chamber is configured to receive material at the bottom side. The accumulator chamber includes an inlet positioned at a front of the bottom side and an outlet positioned at a rear of the bottom side. The baling machine includes an upper conveyor rake that is at least partially positioned within the internal volume of accumulator chamber. The upper conveyor rake has a first end that is pivotally attached to the accumulator chamber adjacent the bottom side of accumulator chamber. The upper conveyor rake has an opposite second end movable within the accumulator chamber. The upper conveyor rake is pivotable within the accumulator chamber between the top side and the bottom side of the accumulator chamber. The baling machine includes a baling chamber inlet that is positioned adjacent the outlet of accumulator chamber. The baling chamber inlet is operable to transfer material from the accumulator chamber to the baling chamber for creation of a round bale.

Example 52. In combination with, or independent thereof, any example disclosed herein, the baling machine includes an overshot rotor rotatable about an overshot rotor axis in a way to convey material over the top side of the overshot rotor. The baling machine includes an overshot rotor stripper positioned at a trailing edge of the overshot rotor. The baling machine includes an undershot rotor rotatable about an undershot rotor axis in a way to convey material under the undershot rotor. The undershot rotor is positioned adjacent to, and downstream from, the overshot rotor. The baling machine includes an undershot rotor drop pan that has a leading edge adjacent the trailing edge of the overshot rotor stripper. The trailing edge of the overshot rotor stripper is positioned at a distance from the undershot rotor axis that is less than a distance that the leading edge of the undershot rotor drop pan is spaced from the undershot rotor axis.

Example 53. In combination with, or independent thereof, any example disclosed herein, the baling machine includes a first torque-limiting device in communication with the overshot rotor. The first torque-limiting device is configured to fluctuate the operating torque of the undershot rotor when a first threshold torque value is exceeded. The baling machine includes a second torque-limiting device in communication with an undershot rotor drive of the overshot rotor. The second torque-limiting device is configured to limit the operating torque of the undershot rotor to a second threshold torque value. The first threshold value is less than the second threshold value.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

1. A baling machine comprising:
an accumulator chamber at least partially defined by a housing, the accumulator chamber including an inlet, an outlet, and an internal volume;
an infeed assembly configured to deliver material to the inlet of the accumulator chamber;
a lower rake assembly positioned within the accumulator chamber, the lower rake assembly being operable to move material toward the outlet of the accumulator chamber; and
an upper conveyor rake being at least partially positioned and movable within the internal volume of the accumulator chamber, the upper conveyor rake having a first end positioned adjacent the outlet of the accumulator chamber, a second end, and a range of motion between a raised position and a lowered position, the second end of the upper conveyor rake having a greater range of motion than the first end.

2. The baling machine of claim 1, wherein the infeed assembly includes an infeed outlet positioned below the inlet of the accumulator chamber.

3. The baling machine of claim 1, wherein the lower rake assembly is positioned at a bottom side of the accumulator chamber.

4. (canceled)

5. The baling machine of claim 1, wherein the lower rake assembly includes a lower conveyor rake and a lower rotor rake, wherein the lower conveyor rake is positioned directly adjacent the inlet of the accumulator chamber and the lower rotor rake is positioned directly adjacent the outlet of the accumulator chamber.

6. The baling machine of claim 5, wherein the lower rotor rake is a rotor that includes a plurality of teeth.

7. The baling machine of claim 6, wherein the plurality of teeth of the lower rotor rake are arranged in a spiraling pattern along the lower rotor rake.

8-10. (canceled)

11. The baling machine of claim 1, wherein the upper conveyor rake includes:
a frame that is pivotally mounted to the housing of the accumulator chamber at the first end; and
a rotatable conveyor body positioned around the frame, wherein the rotatable conveyor body is operable in at least one of a direction toward the outlet of the accumulator chamber and a direction toward the inlet of the accumulator chamber.

12. The baling machine of claim 14, wherein the upper conveyor rake floats on material deposited within the accumulator chamber via the inlet.

13. The baling machine of claim 14, wherein material deposited within the accumulator chamber via the inlet exerts an upward force on the upper conveyor rake.

14. The baling machine of claim 11, wherein, when in the lowered position, at least a portion of the upper conveyor rake is generally vertically positioned over at least a portion of the inlet of the accumulator chamber.

15. (canceled)

16. The baling machine of claim 11, wherein the upper conveyor rake is biased toward the lowered position via a biasing member.

17. (canceled)

18. The baling machine of claim 16, wherein the biasing member is a hydraulic cylinder.

19. The baling machine of claim 11, wherein the upper conveyor rake is powered at the first end by an upper conveyor driving input, wherein the upper conveyor driving input is configured to rotate the rotatable conveyor body around the frame of the upper conveyor rake.

20. The baling machine of claim 19, wherein the upper conveyor driving input is in communication with a hydraulic motor.

21. The baling machine of claim 1, further comprising a sensor operable to sense at least one of a position, a speed, and a load of the upper conveyor rake.

22. The baling machine of claim 21, further comprising a controller in communication with the sensor, wherein the controller alters the behavior of the upper conveyor rake based on a signal received from the sensor.

23. The baling machine of claim 1, further comprising a baling chamber inlet positioned adjacent the outlet of the accumulator chamber, the baling chamber inlet being operable to transfer material from the accumulator chamber to a baling chamber for creation of a round bale.

24-51. (canceled)
